(19) United States
(12) Patent Application Publication
(10) Pub. No.: US 2012/0184311 A1
(43) Pub. Date: Jul. 19, 2012

(54) BASE STATION DEVICE

(75) Inventors: Takashi Yamamoto, Osaka-shi (JP); Kenichi Murakami, Osaka-shi (JP); Yoshizo Tanaka, Osaka-shi (JP); Yoshiyuki Shimada, Osaka-shi (JP)

(73) Assignee: SUMITOMO ELECTRIC INDUSTRIES, LTD., Osaka-shi (JP)

(21) Appl. No.: 13/498,386

(22) PCT Filed: Oct. 7, 2010
(86) PCT No.: PCT/JP2010/067630

§ 371 Date: Mar. 27, 2012

(30) Foreign Application Priority Data
Oct. 7, 2009 (JP) 2009-233877

(51) Int. Cl. H04W 4/00; H04B 15/00

(52) U.S. Cl. 455/502; 455/524

(57) ABSTRACT

The present invention relates to a base station device 1 that performs wireless communication with a terminal device 2 existing in its cell. The base station device 1 includes an obtainment unit (reception unit 12) that obtains control information for another base station device 1 to achieve synchronization with the another base station device 1, and a selection unit (synchronization control unit 40) that selects the another base station device 1 to be a synchronization source, based on identification information that specifies the type of the another base station device 1, the identification information being included in the control information.

### TECHNICAL FIELD

The present invention relates to a base station device capable of achieving synchronization with another base station device that performs wireless communication with a terminal device existing in its cell.

### BACKGROUND ART

A number of base station devices, each performing wireless communication with terminal devices (wireless communication terminals), are provided to cover a wide area. At this time, inter-base-station synchronization may be performed to achieve synchronization of communication frame timings or the like among a plurality of base station devices.

For example, Patent Literature 1 discloses inter-base-station synchronization (over-the-air synchronization) using a radio wave transmitted from another base station device that is a synchronization source.

### CITATION LIST

### Patent Literature

[PTL 1] Japanese Laid-Open Patent Publication No. 2009-177532

### SUMMARY OF THE INVENTION

### Problems to be Solved by the Invention

This type of base station devices are roughly classified into: macro base stations (transmission power=about 2 W to 40 W) each forming a macro cell having a size of about 500 m or larger; and small base stations (transmission power=2 W or less) each forming a relatively small cell (smaller than about 500 m).

Examples of small base stations include: a pico base station that has a transmission power of about 200 mW to 2 W, and forms a pico cell having a size of about 100 m to 500 m; and a femto base station that has a transmission power of about 20 mW to 200 mW, and forms a femto cell having a size of 100 m or smaller.

The small base stations (in particular, femto base stations) are installed in buildings or basements or between buildings, where radio waves from macro base stations do not reach. Thus, the small base stations are used to complement the macro base station devices, and improve the communication environment.

Accordingly, many small base stations cannot receive GPS signals. Therefore, it is preferable to optimize clock frequencies by using the above-mentioned inter-base-station synchronization.

However, when a certain small base station arbitrarily selects a synchronization source when it performs inter-base-station synchronization, and then if the small base station selects, as a synchronization source, another small base station having a time lag, a group (synchronization network) of a plurality of small base stations having a time lag may undesirably be formed.

In this case, when a mobile terminal existing in the cell of the small base station that forms the group having a time lag moves into a macro cell, appropriate handover is not performed, leading to a possibility that communication failure may occur in the terminal device.

In contrast to the small base stations, the macro base stations are, so to speak, public base station devices installed by telecommunications carriers and, in many cases, are operated by accurate synchronization signals based on GPS signals or the like. Therefore, it is preferable that a small base station is synchronized with the time of a macro base station.

Further, since a femto cell formed by a femto base station device is usually located in a macro cell, almost the entire area of the femto cell may overlap with the macro cell. Moreover, a femto base station device may be installed in an arbitrary position in a macro cell by a user.

Therefore, a downlink signal from a femto base station device may cause interference to a terminal device connected to a macro base station device, or an uplink signal transmitted by a terminal device connected to a femto base station device may cause interference to a macro base station device.

Further, a plurality of femto base station devices that form neighboring femto cells and terminal devices connected to the femto base station devices may interfere with each other.

In order to avoid such interference, it is considered that a resource used by a macro base station device and a resource used by a femto base station device are adjusted and allocated so as not to overlap with each other in the frequency direction or the time direction.

In order to adjust and allocate the resources of these base station devices so as not to overlap with each other, it is essential that the radio frames of the base station devices should be synchronized with each other.

Accordingly, as described above, in order to avoid interference between base stations, it is preferable that inter-base-station synchronization is achieved with a base station device that is highly likely to cause interference.

The present invention is made to solve the problems described above, and an object of the present invention is to provide a base station device that forms an accurate synchronization group by autonomously selecting a large-scale base station device as a synchronization source.

Another object of the present invention is to provide a base station device that can achieve synchronization with a base station device that is highly likely to cause interference, in order to favorably perform a process for avoiding interference.

### Solution to the Problems

(1) The present invention is a base station device that performs wireless communication with a terminal device existing in its cell, and the base station device includes: an obtainment unit that obtains control information for another base station device to achieve synchronization with the another base station device; and a selection unit that selects the another base station device to be a synchronization source, based on identification information that identifies the type of the another base station device, the identification information being included in the control information.

According to the base station device of the present invention, the obtainment unit obtains the control information for the another base station device, and the selection unit selects the another base station device to be a synchronization source, based on the identification information that is included in the control information and specifies the type of the another base station device. Therefore, even when a plurality of types of other base station devices having different scales of communication areas exist in the vicinity of the base station device that performs a synchronization process, the base station device can autonomously select, as a synchronization source, from among the other base station devices, a large-scale base station device that is highly likely to be accurate in time.

(2) In the base station device of the present invention, specifically, either of the following (a) and (b) may be used as the identification information:

(a) type information indicating whether the another base station device is a macro base station or a small base station;

(b) transmission power information of the another base station device.

In this case, when (a) the type information is used, it is possible to directly determine whether the another base station device is a macro base station or a small base station.

On the other hand, when (b) the transmission power information is used, it is possible to indirectly determine whether the another base station device is a macro base station or a small base station by comparing a power value obtained from this information with a predetermined threshold.

(3) In the base station device of the present invention, it is preferable that the selection unit selects, as a synchronization source, the another base station device which is a macro base station.

The reason is as follows. As described above, macro base stations are, in many cases, operated by accurate synchronization signals based on GPS signals or the like, and are highly likely to be accurate in time. Therefore, it is preferable to select a macro base station as a synchronization source.

(4) Further, in the base station device of the present invention, the obtainment unit may comprise a reception unit that receives a downlink signal that is transmitted by the another base station device, and includes the identification information. In this case, when there are a plurality of the other base station devices which are macro base stations, it is preferable that the selection unit preferentially selects, as a synchronization source, a base station device that transmits a downlink signal having a higher reception power (reception level) in the reception unit.

The reason is as follows. The higher the reception intensity in the reception unit, the more accurately and reliably the base station device can perform the synchronization process.

(5) On the other hand, in the base station device of the present invention, it is preferable that the selection unit does not select, as a synchronization source, the another base station device which is a small base station.

The reason is as follows. As described above, small base stations are installed in buildings and basements, and therefore, are less likely to be operated by accurate synchronization signals based on GPS signals or the like, and are highly likely to be inaccurate in time. Accordingly, it should be avoided to select a small base station as a synchronization source.

(6) However, it is considered that a small base station that adopts a macro base station as a direct synchronization source has approximately the same time accuracy as the macro base station.

Accordingly, in the base station device of the present invention, the selection unit may select the another base station device which is a small base station, as a synchronization source, when the another base station device adopts a macro base station as a direct synchronization source.

(7) Further, the present invention is a base station device that performs wireless communication with a terminal device existing in its cell, and the base station device includes a selection unit that selects another base station device to be a synchronization source, based on information indicating whether interference can occur due to a relationship between the base station device and the another base station device.

According to the base station device of the above-mentioned configuration, the selection unit selects another base station device to be a synchronization source, based on information indicating whether interference can occur due to a relationship between the base station device and the another base station device. Therefore, the base station device can achieve synchronization with another base station device that can cause interference. As a result, the base station device can favorably perform a process for avoiding interference.

(8) More specifically, in the above-mentioned base station device, it is preferable that the information indicating whether interference can occur due to a relationship between the base station device and the another base station device is identification information that specifies whether the another base station device is a macro base station or a small base station.

(9) The closer the another base station device is to the base station device, the higher the possibility that the downlink signals from the base station device and the another base station device cause interferences to the terminal devices connected to these base station devices. In order to avoid such interferences, it is preferable that the base station device achieves inter-base-station synchronization with the another base station device located near the base station device.

Accordingly, in the base station device described in section (7), it is preferable that the information indicating whether interference can occur due to a relationship between the base station device and the another base station device is information indicating a positional relationship between the base station device and the another base station device, or information whose value is influenced by the positional relationship between the base station device and the another base station device.

In this case, the selection unit selects another base station device to be a synchronization source, based on the information indicating the positional relationship between the base station device and the another base station device, or the information whose value is influenced by the positional relationship between the base station device and the another base station device. Accordingly, the above-mentioned information allows the selection unit to select, as a synchronization source, another base station device that is relatively near the base station device and therefore is determined as being highly likely to cause interference.

As a result, the base station device can achieve synchronization with another base station device that is highly likely to cause interference, and can favorably perform the process for avoiding interference.

(10) More specifically, it is preferable that the information whose value is influenced by the positional relationship between the base station device and the another base station device is information relating to a detection result obtained when a downlink signal from the another base station device is detected, or a reception level of the downlink signal from the another base station device, or a path-loss value between the base station device and the another base station device.

(11) (12) Further, it is preferable that the information relating to a detection result obtained when a downlink signal from the another base station device is detected is the number of times the another base station device is detected within a predetermined time period, or a detection rate that is a ratio of the number of times the another base station device is detected, to the number of times the detection is executed.

Alternatively, the information relating to a detection result obtained when a downlink signal from the another base station device is detected may be the time at which the downlink signal from the another base station device has been detected most recently, or the elapsed time from that time to the present time.

(13) In the base station device described in section (9), the information whose value is influenced by the positional relationship between the base station device and the another base station device may be information relating to the number of trials of handover by the terminal device, the handover being performed between the base station device and the another base station device, or information whose value is influenced by the number of trials of handover.

The larger the number of trials of handover, the higher the possibility that the another base station device is located near the base station device. Therefore, when the number of trials of handover is relatively large, the possibility of interference between the base station device and the another base station device is increased.

Accordingly, in this case, the selection unit selects another base station device to be a synchronization source in accordance with the number of trials of handover. Therefore, the selection unit can select, as a synchronization source, another base station device that has a relatively large number of trials of handover and therefore is determined as being highly likely to cause interference.

(14) When the carrier wave frequency of the another base station device is the same as that of the base station device, the possibility that the downlink signals of these base station devices cause interferences to the terminal devices connected to these base station devices is increased.

Further, the larger the number of terminal devices connected to the another base station device, the higher the possibility that the base station device causes interference to the terminal devices connected to the another base station device.

Furthermore, an access mode defines limitation on connection of terminal devices to the another base station device, and indicates the communality of the another base station device. For example, when the another base station device is in a mode in which the degree of limitation on connection of terminal devices is low, the another base station device is highly public, and the possibility that many terminal devices are connected to the another base station device is high. Accordingly, in an access mode, the lower the degree of limitation on connection of terminal devices, the higher the possibility that another base station device in this access mode causes interference.

Further, when the power of the another base station device is off, no interference occurs between the base station device and the another base station device.

Accordingly, in the base station device described in section (7), the information indicating whether interference can occur due to a relationship between the base station device and the another base station device is, preferably, information indicating a carrier wave frequency of the another base station device, information indicating an access mode of the another base station device to a terminal device connected to the another base station device, the estimated number of terminal devices connected to the another base station device, or information indicating a power ON/OFF state of the another base station device.

(15) (16) The selection unit may select the another base station device to be a synchronization source, based on, in addition to the information indicating whether interference can occur due to a relationship between the base station device and the another base station device, information indicating whether the interference is avoidable. In this case, it is possible to favorably avoid interference with another base station device that can cause interference.

More specifically, the information indicating whether the interference is avoidable is, preferably, information indicating the type of a radio access technology adopted by the another base station device, information indicating a resource block allocation scheme used when the another base station device performs resource allocation to a terminal device connected to the another base station device, or information indicating whether inter-base-station communication is possible between the base station device and the another base station device.

### Advantageous Effects of the Invention

As described above, according to the base station device of the present invention, a large-scale base station device is autonomously selected as a synchronization source. Therefore, it is possible to form an accurate synchronization group, without the necessity of providing all base station devices with expensive devices such as GPS receivers.

Further, according to the base station device of the present invention, it is possible to achieve synchronization with a base station device that is highly likely to cause interference.

### BRIEF DESCRIPTION OF THE DRAWINGS

FIG. 1 is a diagram showing a schematic configuration of a wireless communication system.

FIG. 2 is an image diagram showing structures of uplink and downlink frames for LTE.

FIG. 3 is a diagram showing a structure of a DL frame for LTE.

FIG. 4 is a block diagram showing an internal configuration of a base station device (femto base station).

FIG. 5 is a block diagram showing an internal configuration of a synchronization processing unit.

FIG. 6 is a flowchart showing a synchronization-source selection process by a synchronization control unit.

FIG. 7 is a partial block diagram showing a part of an internal configuration of a femto base station device according to a second embodiment of the present invention.

FIG. 8 is a diagram showing an example of arrangement of femto base station devices according to the second embodiment in a wireless communication system.

FIG. 9 is a diagram showing a manner of connection of each base station device to a communication network.

FIG. 10 is a sequential diagram showing an example of a procedure in which a femto base station device according to the second embodiment obtains measurement result information.

FIG. 11(a) is a diagram showing an example of neighboring cell information stored in the femto base station device, and FIG. 11(b) is a diagram showing an example of neighboring cell information stored in a femto base station device according to a first modification of the second embodiment.

FIG. 12(a) is a diagram showing an example of detection result of other base station devices detected when the femto base station device according to a second modification of the second embodiment obtains measurement result information, and FIG. 12(b) is a diagram showing an example of neighboring cell information generated by a neighboring cell information generation unit of this modification based on the detection result shown in FIG. 12(a).

FIG. 13(a) is a diagram showing an example of detection result of other base station devices detected when the femto base station device according to a second modification of the second embodiment obtains measurement result information, and FIG. 13(b) is a diagram showing an example of neighboring cell information generated by a neighboring cell information generation unit of this modification based on the detection result shown in FIG. 13(a).

FIG. 14 is a partial block diagram showing a part of a femto base station device according to a third embodiment of the present invention.

FIG. 15 is a sequential diagram showing an example of a manner of obtaining handover information, during handover performed by the femto base station device according to the third embodiment with a terminal device.

FIG. 16 is a diagram showing an example of a manner of updating the neighboring cell information by the femto base station device, when handover is performed in the procedure shown in FIG. 15.

FIG. 17 is a diagram showing another example of a manner of updating the neighboring cell information by the femto base station device when handover is performed.

FIG. 18 is a block diagram showing a part of an internal configuration of a femto base station device according to a fourth embodiment of the present invention.

FIG. 19 is a diagram showing the contents of access modes set in the base station device.

FIG. 20(a) is a diagram showing an example of neighboring cell information generated by the femto base station device according to the fourth embodiment, and FIG. 20 (b) is a diagram showing another example of neighboring cell information generated by the femto base station device according to the fourth embodiment.

FIG. 21 is a diagram showing an example of neighboring cell information generated by a femto base station device according to a modification of the fourth embodiment.

FIG. 22 is a block diagram showing a part of an internal configuration of a femto base station device according to a fifth embodiment of the present invention.

FIG. 23 is a diagram showing an example of neighboring cell information generated by the femto base station device according to the fifth embodiment.

FIG. 24 is a block diagram showing a part of an internal configuration of a femto base station device according to a sixth embodiment of the present invention.

FIG. 25 is a diagram showing an example of neighboring cell information generated by the femto base station device according to the sixth embodiment.

### DESCRIPTION OF EMBODIMENTS

Preferred embodiments of the present invention will be described below with reference to the accompanying drawings.

### 1. First Embodiment

### Configuration of Communication System

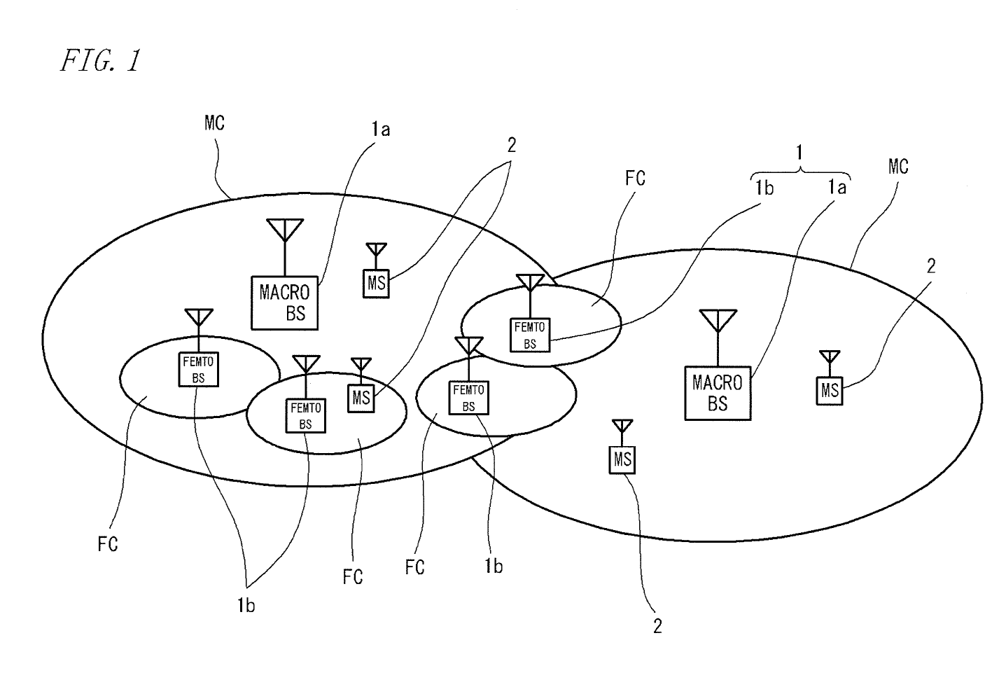

FIG. 1 is a diagram showing a schematic configuration of a wireless communication system including a base station device according to a first embodiment of the present invention.

This wireless communication system includes a plurality of base station devices 1, and a plurality of terminal devices 2 (mobile stations) that are allowed to perform wireless communication with the base station devices 1.

The plurality of base station devices 1 include: a plurality of macro base stations 1a each forming a communication area (macro cell) MC having a size of several kilometers; and a plurality of femto base stations 1b each forming a relatively small femto cell FC having a size of several tens of meters, and being located in the macro cells MC.

Each macro base station (hereinafter, also referred to as “macro BS”) 1a is allowed to perform wireless communication with a terminal device 2 existing in its own macro cell MC.

On the other hand, each femto base station (hereinafter, also referred to as “femto BS”) 1b is installed in a place, such as a basement or house, where a radio wave from a macro BS 1a is hardly received, and forms a femto cell FC. Each femto BS 1b is allowed to perform wireless communication with a terminal device (hereinafter, also referred to as “MS”) existing in its own femto cell FC.

In the wireless communication system, even in a place where a radio wave from the macro BS 1a is hardly received, it is possible to provide an MS 2 with a service with a sufficient throughput, by installing a femto BS 1b that forms a relatively small femto cell FC in the place.

That is, a femto BS 1b is installed in an arbitrary position by a user.

In the above-mentioned wireless communication system, a femto BS 1b is installed in a macro cell MC formed by a macro BS 1a, and then forms a femto cell FC in the macro cell MC. Therefore, the femto BS 1b might cause interference or the like with the macro BS 1a.

So, the femto BS 1b has a function of performing monitoring (measurement) of the transmission conditions such as the transmission power and the operating frequency of another base station device 1 (either a macro BS or a femto BS), and a function of adjusting, based on the monitoring result, the transmission conditions such as the transmission power and the operating frequency so as not to affect communication in the macro cell MC.

These functions allow the femto BS 1b to form the femto cell FC in the macro cell MC without affecting communication in the macro cell MC.

Further, in the communication system of the present embodiment, inter-base-station synchronization is performed, in which synchronization of communication frame timings is achieved among the plurality of base station devices 1 including the macro BSs 1a and the femto BSs 1b. The inter-base-station synchronization is executed by “over-the-air synchronization” in which a signal transmitted by a base station device serving as a master (synchronization source) to an MS 2 existing in its own cell, is received by another base station device, thereby achieving synchronization.

The master base station device 1 may achieve over-the-air synchronization with still another base station device 1, or may determine a frame timing by any other method than over-the-air synchronization, such as autonomously determining a frame timing by using a GPS signal.

In the present embodiment, however, a macro BS 1a can select another macro BS 1a as a master, but cannot select a femto BS 1b as a master. Likewise, a femto BS 1b can select a macro BS 1a as a master, but cannot select another femto BS 1b as a master.

The wireless communication system of the present embodiment is, for example, a mobile phone system to which LTE (Long Term Evolution) is applied, and communication based on LTE is performed between each base station device 1 and each terminal device 2. In LTE, frequency division duplex (FDD) can be adopted. So, hereinafter, a description will be given on assumption that FDD is adopted.

However, communication systems to which the present invention is applicable are not limited to those based on LTE, and WCDMA or CDMA2000 may be adopted. Further, LTE may adopt not only FDD but also TDD (Time Division Duplex).

[Frame Structure for LTE]

In FDD that can be adopted by LTE, uplink communication and downlink communication are simultaneously performed by allocating different operating frequencies to an uplink signal (a transmission signal from a terminal device 2 to a base station device 1) and a downlink signal (a transmission signal from the base station device 1 to the terminal device 2).

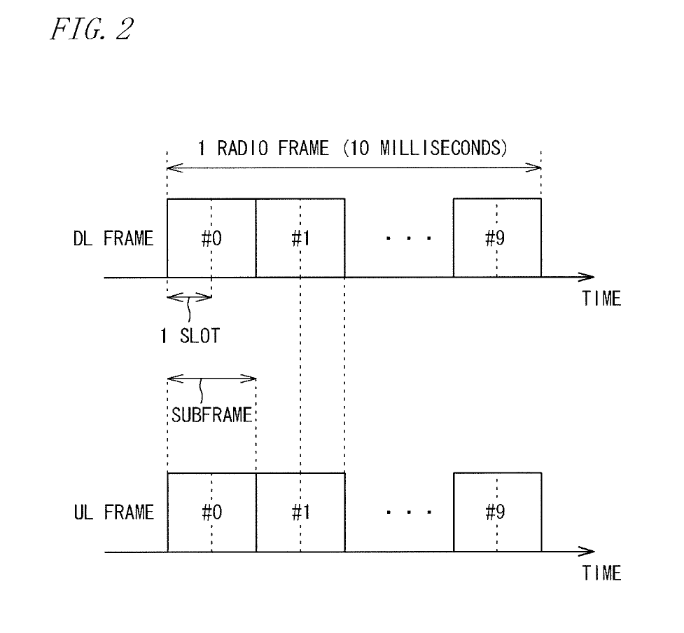

FIG. 2 is a diagram illustrating the structures of uplink and downlink communication frames for LTE.

As shown in FIG. 2, each of a downlink frame (DL frame) and an uplink frame (UL frame) for LTE has a time length of 10 milliseconds, and consists of 10 subframes #0 to #9. The DL frames and the UL frames are arranged in the time axis direction with the frame timings coinciding with each other.

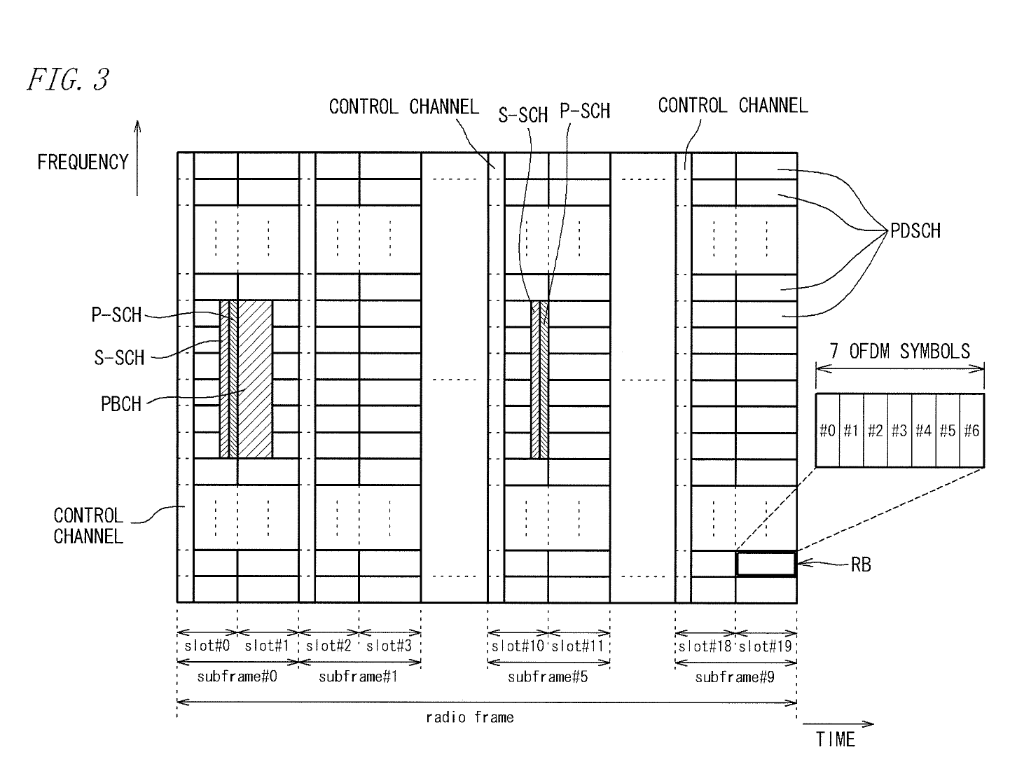

FIG. 3 is a diagram illustrating the structure of a DL frame in detail. In FIG. 3, the vertical axis direction indicates the frequency, and the horizontal axis direction indicates the time.

As shown in FIG. 3, each of subframes that form the DL frame consists of 2 slots (e.g., slot #0 and slot #1), and one slot consists of 7 OFDM symbols (in the case of Normal Cyclic Prefix).

Further, in FIG. 3, a resource block (RB) which is a fundamental unit for data transmission is defined by 12 subcarriers in the frequency axis direction and 7 OFDM symbols (1 slot) in the time axis direction.

Accordingly, when the frequency band width of the DL frame is set at, for example, 5 MHz, 300 subcarriers are arranged, and 25 resource blocks are arranged in the frequency axis direction.

As shown in FIG. 3, a control channel for transmitting, from a base station device to a terminal device, information required for downlink communication is allocated to the beginning of each subframe.

The control channel is allocated to symbols #0 to #2 (three symbols at maximum) in slot #0 in each subframe. The control channel has, stored therein, DL control information, resource allocation information of the corresponding subframe, an acknowledgement (ACK) and a negative acknowledgement (NACK) of a hybrid automatic report request (HARQ), and the like.

Further, in the DL frame, a physical broadcast channel (PBCH) for notifying a terminal device of the band width or the like of the system by broadcasting is allocated to the 0th subframe #0.

The physical broadcast channel is arranged, in the time axis direction, in the position corresponding to symbols #0 to #3 in the second slot #1 in the first subframe #0 so as to have a width corresponding to 4 symbols, and arranged, in the frequency axis direction, in the center of the band width of the DL frame so as to have a width corresponding to 6 resource blocks (72 subcarriers).

The physical broadcast channel is configured to be updated every 40 milliseconds by transmitting the same information over four frames. The physical broadcast channel has, stored therein, major system information such as the communication band width, the number of transmission antennas, the structure of the control information, and the like.

Further, among the 10 subframes that form the DL frame, the 0th (#0) and 6th (#5) subframes are each allocated a primary synchronization channel (P-SCH) and a secondary synchronization channel (S-SCH) which are signals for identifying a base station device or a cell.

The primary synchronization channel is arranged, in the time axis direction, in the position corresponding to symbol #6 that is the last OFDM symbol in the first (#0) slot in each of subframes #0 and #5 so as to have a width corresponding to one symbol, and arranged, in the frequency axis direction, in the center of the band width of the DL frame so as to have a width corresponding to 6 resource blocks (72 subcarriers).

The primary synchronization channel is information by which a terminal device 2 identifies each of a plurality of (three) sectors into which a cell of a base station device 1 is divided, and 3 patterns are defined.

The secondary synchronization channel is arranged, in the time axis direction, in the position corresponding to symbol #5 that is the second last OFDM symbol in slot #0 in each of subframes #0 and #5 so as to have a width corresponding to one symbol, and arranged, in the frequency axis direction, in the center of the band width of the DL frame so as to have a width corresponding to 6 resource blocks (72 subcarriers).

The secondary synchronization channel is information by which a terminal device 2 identifies each of the communication areas (cells) of a plurality of base station devices 1, and 168 patterns are defined.

By combining the primary and secondary synchronization channels, 504 (163×3) patterns are defined. When a terminal device 2 obtains the primary and secondary synchronization channels transmitted from a base station device 1, the terminal device 2 can recognize in which sector of which base station device 1 the terminal device 2 exists.

A plurality of patterns that the primary synchronization channel and the secondary synchronization channel can take are defined in advance in the communication standard, and are known by each base station device 1 and each terminal device 1. That is, each of the primary synchronization channel and the secondary synchronization channel is a known signal that can take a plurality of patterns.

The resource blocks in a region (a region without hatching in FIG. 3) to which the above-mentioned channels are not allocated are used as a physical downlink shared channel (PDSCH) in which user data and the like are stored.

Allocation of user data to be stored in the PDSCH is defined by resource allocation information in the control channel that is allocated to the beginning of each subframe, and the resource allocation information allows the terminal device 2 to determine whether data for the terminal device 2 is stored in the subframe.

Further, in order to make the amount of broadcast information transmitted to the terminal device 2 flexibly variable depending on the environment, the PDSCH has, stored therein, a plurality of SIBs (System Information Blocks) in addition to the user data.

Among the plurality of SIBs stored in the PDSCH, for example, an SIB of type 9 (SIB 9) includes a flag indicating whether its own base station device is a femto BS 1b. Therefore, the terminal device 2 can recognize whether the base station device 1 as the transmission source is a macro base station 1a or a femto base station 1b depending on whether the flag included in the SIB 9 is ON.

Further, among the plurality of SIBs, for example, an SIB of type 2 (SIB 2) has, stored therein, transmission power information of its own base station device.

As described above, the transmission power of the macro base station 1a is about 2 W to 40 W, while the transmission power of the femto base station 1b is about 20 W to 200 mW. Accordingly, the terminal device 2 can recognize whether the base station device 1 as the transmission source is a macro base station 1a or a femto base station 1b, by determining whether or not the transmission power included in the SIB 2 is equal to or higher than a predetermined threshold.

[Configuration of Femto Base Station]

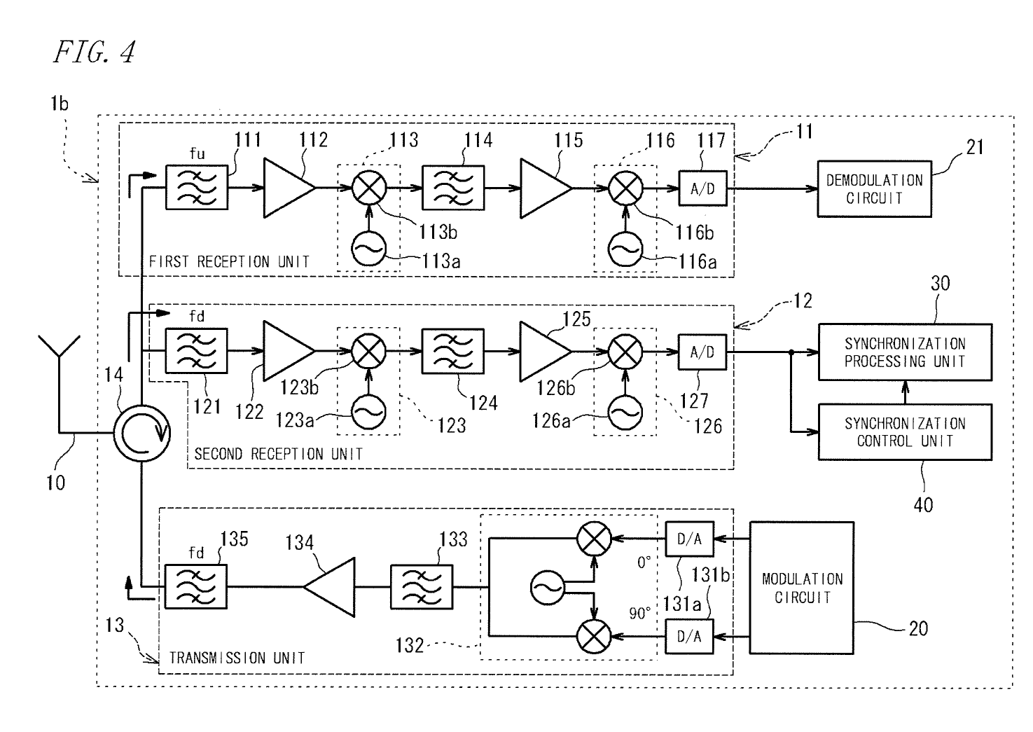

FIG. 4 is a block diagram showing the internal configuration of a femto BS 1b. A macro BS 1a has substantially the same configuration as the femto BS 1b.

As shown in FIG. 4, the femto BS 1b includes an antenna 10, a first reception unit 11, a second reception unit 12, a transmission unit 13, and a circulator 14.

Among these components, the first reception unit 11 receives an uplink signal from a terminal device 2, and the second reception unit 12 receives a downlink signal from another base station device 1. The transmission unit 13 transmits a downlink signal to the terminal device 2.

The circulator 14 provides a reception signal from the antenna 10 to the first reception unit 11 and the second reception unit 12, and provides a transmission signal outputted from the transmission unit 13 to the antenna 10.

The circulator 14 and a fourth filter 135 in the transmission unit 13 prevent the reception signal from the antenna 10 from being transmitted to the transmission unit 13. Further, the circulator 14 and a first filter 111 in the first reception unit prevent the transmission signal outputted from the transmission unit 13 from being transmitted to the first reception unit 11.

Furthermore, the circulator 14 and a fifth filter 121 prevent the transmission signal outputted from the transmission unit 13 from being transmitted to the second reception unit 12.

The first reception unit 11 is configured as a superheterodyne receiver so as to perform IF (Intermediate Frequency) sampling.

More specifically, the first reception unit 11 includes a first filter 111, a first amplifier 112, a first frequency converter 113, a second filter 114, a second amplifier 115, a second frequency converter 116, and an A/D converter 117.

The first filter 111 is implemented by a band-pass filter that allows only the frequency fu of the uplink signal from the terminal device 2 to pass therethrough. The reception signal having passed through the first filter 111 is amplified by the first amplifier (high-frequency amplifier) 112, and then subjected to frequency conversion from the frequency fu to a first intermediate frequency by the first frequency converter 113.

Note that the first frequency converter 113 includes an oscillator 113a and a mixer 113b.

The output from the first frequency converter 113 passes through a second filter 114 that allows only the first intermediate frequency to pass therethrough, and is again amplified by the second amplifier (intermediate frequency amplifier) 115.

The output from the second amplifier 115 is subjected to frequency conversion from the first intermediate frequency to a second intermediate frequency by the second frequency converter 116, and is converted to a digital signal by the A/D converter 117. Note that the second frequency converter 116 also includes an oscillator 116a and a mixer 116b.

The output from the A/D converter 117 (the output from the first reception unit 11) is provided to a demodulation circuit 21 (digital signal processing unit), and the reception signal from the terminal device is subjected to demodulation.

Thus, the first reception unit 11 converts the analog uplink signal received by the antenna 10 to a digital signal, and provides the digital uplink signal to the demodulation circuit 21 that is configured as a digital signal processing unit.

On the other hand, the transmission unit 13 receives modulated signals I and Q outputted from a modulation circuit 20 (digital signal processing unit), and causes the antenna 10 to transmit the signals. The transmission unit 13 is configured as a direct conversion transmitter.

The transmission unit 13 includes D/A converters 131a and 131b, an orthogonal modulator 132, a third filter 133, a third amplifier (high power amplifier; HPA) 134, and a fourth filter 135.

The D/A converters 131a and 131b perform D/A conversion on the modulated signals I and Q, respectively. The outputs from the D/A converters 131a and 131b are provided to the orthogonal modulator 132, and the orthogonal modulator 132 generates a transmission signal having a carrier wave frequency fd (downlink signal frequency).

The output from the orthogonal modulator 132 passes through the third filter 133 that allows only the frequency fd to pass therethrough, and is amplified by the third amplifier 134. The output from the third amplifier 134 passes through the fourth filter 135 that allows only the frequency fd to pass therethrough, and is transmitted from the antenna 10 as a downlink signal to the terminal device 2.

While the first reception unit 11 and the transmission unit 13 are necessary for performing essential communication with the terminal device 2, the femto BS 1b of the present embodiment further includes the second reception unit 12.

The second reception unit 12 receives a downlink signal transmitted by another base station device 1 to achieve over-the-air synchronization.

The femto BS 1b needs to receive the downlink signal transmitted by the another base station device 1 to achieve over-the-air synchronization with the another base station device 1. However, the frequency of the downlink signal is fd which is different from the frequency fu of the uplink signal. Therefore, the first reception unit 11 cannot receive the downlink signal.

That is, the first reception unit 11 includes the first filter 111 that allows only a signal of the frequency fu to pass therethrough, and the second filter 114 that allows only the first intermediate frequency into which the frequency fu is converted to pass therethrough. Therefore, if a signal of a frequency (the downlink signal frequency fd) other than the frequency fu is provided to the first reception unit 11, this signal is not allowed to pass through the first reception unit 11.

That is, the first reception unit 11 including the filters 111 and 114 complies with reception of a signal of the uplink signal frequency fu, and therefore, cannot receive signals of other frequencies.

Accordingly, the femto BS 1b of the present embodiment includes, separately from the first reception unit 11, the second reception unit 12 for receiving the downlink signal of the frequency fd, which is transmitted by the another base station device 1.

The second reception unit 12 includes a fifth filter 121, a fourth amplifier (high-frequency amplifier) 122, a third frequency converter 123, a sixth filter 124, a fifth amplifier (intermediate frequency amplifier) 125, a fourth frequency converter 126, and an A/D converter 127.

The fifth filter 121 is implemented by a band-pass filter that allows only the frequency fd of the downlink signal from the another base station device 1 to pass therethrough.

The reception signal having passed through the fifth filter 121 is amplified by the fourth amplifier (high-frequency amplifier) 122. The output from the fourth amplifier 122 is subjected to frequency conversion from the downlink signal frequency fd to the first intermediate frequency by the third frequency converter 123. Note that the third frequency converter 123 includes an oscillator 123a and a mixer 123b.

The output from the third frequency converter 123 passes through the sixth filter 124 that allows only the first intermediate frequency outputted from the third frequency converter 123 to pass therethrough, and is again amplified by the fifth amplifier (intermediate frequency amplifier) 125.

The output from the fifth amplifier 125 is subjected to frequency conversion from the first intermediate frequency to the second intermediate frequency by the fourth frequency converter 126, and is further converted to a digital signal by the A/D converter 127. Note that the fourth frequency converter 126 also includes an oscillator 126a and a mixer 126b.

[Over-the-Air Synchronization Process]

The output signal from the A/D converter 127 in the second reception unit 12 is provided to a synchronization processing unit 30 in the subsequent stage.

Based on the primary and secondary synchronization channels (known signals) included in the downlink signal obtained from the another base station device 1 as a synchronization source (the master BS 1a in the present embodiment), the synchronization processing unit 30 performs over-the-air synchronization for achieving synchronization of the communication timing and the communication frequency of its own base station device 1 (the femto BS 1b in the present embodiment).

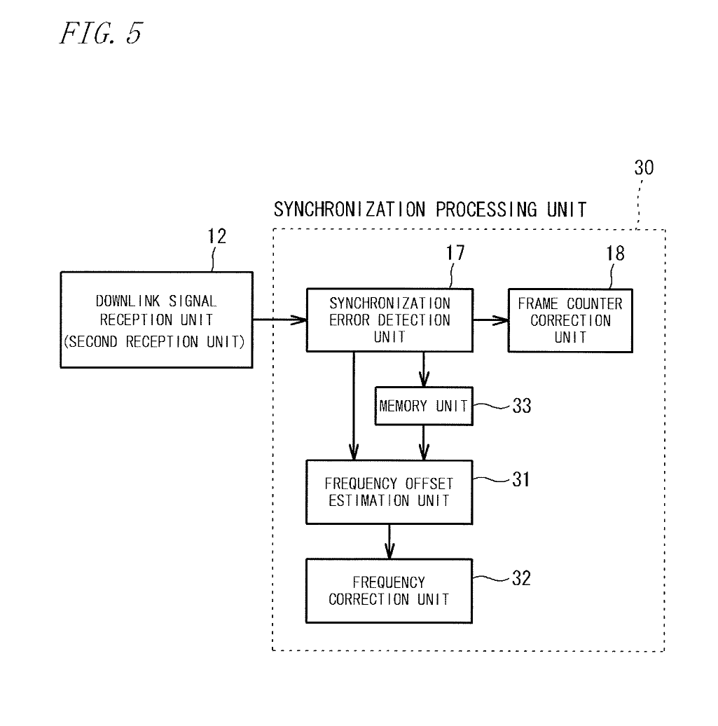

FIG. 5 is a block diagram showing the configuration of the synchronization processing unit 30.

As shown in FIG. 5, the synchronization processing unit 30 includes a frame synchronization error detection unit 17, a frame counter correction unit 18, a frequency offset estimation unit 31, a frequency correction unit 32, and a memory unit 33.

The frame synchronization error detection unit 17 detects a frame transmission timing of the another base station device 1 by using the primary and secondary synchronization channels included in the downlink signal, and detects an error (frame synchronization error; communication timing offset) between the detected frame transmission timing and the frame transmission timing of the base station device 1b.

Note that detection of transmission timing can be performed by detecting the timings of the known signals (waveforms thereof are also known) existing in the predetermined positions in the frame of the received downlink signal. Further, when the second reception unit 12 receives the downlink signal for synchronization, the transmission unit 13 suspends transmission.

The synchronization error detected by the detection unit 17 is provided to the frame counter correction unit 18, and used for correction of the frame synchronization error. In addition, the synchronization error is provided to the memory unit 33 each time it is detected, and the value of the error is accumulated in the memory unit 33.

On the other hand, the frequency offset estimation unit 31 estimates, based on the synchronization error detected by the detection unit 17, an error (clock frequency error) between a clock frequency of a clock generator (not shown) contained in the base station device as the receiving side and a clock frequency of a clock generator contained in the another base station device 1 as the transmitting side, and estimates a carrier frequency error (carrier frequency offset) from the clock frequency error.

Under the situation where over-the-air synchronization is periodically performed, the frequency offset estimation unit 31 estimates a clock error based on a frame synchronization error t1 detected in the last over-the-air synchronization and a frame synchronization error t2 detected in the current over-the-air synchronization. Note that the last frame synchronization error t1 can be obtained from the memory unit 33.

For example, it is assumed that, when the carrier frequency is 2.6 [GHz], a frame synchronization error T1 has been detected at the timing of the last over-the-air synchronization (synchronization timing=t1), and correction of timing by an amount corresponding to T1 has been performed. In this case, the synchronization error (timing offset) after the correction is 0 [msec].

Then, it is assumed that, also at the timing of the current over-the-air synchronization (synchronization timing=t2) performed T=10 seconds later, a synchronization error (timing offset) is detected again, and the synchronization error (timing offset) is T2=0.1 [msec].

At this time, the synchronization error (timing offset) of 0.1 [msec] having occurred during the 10 seconds is an accumulated value of the error between the clock period of the another base station device 1 and the clock period of the base station device 1b.

That is, the following equation is established between the synchronization error (timing offset) and the clock period.

the clock period of the synchronization source: the clock period of the own base station=T:(T+T2)=10:(10+0.0001)

Since the clock frequency is the reciprocal of the clock period,

$$( the clock frequency of the synchronization \text{-} source base station - the clock frequency of the synchronization \text{-} target base station ) = the clock frequency of the synchronization \text{-} source base station \times T 2 / ( T + T 2 ) \approx the clock frequency of the synchronization \text{-} source base station \times 0.00001$$

Accordingly, in this case, there is an error of 0.00001=10 [ppm] between the clock frequency of the another base station device 1 as the transmitting side and the clock frequency of the base station device 1b as the receiving side. The frequency offset estimation unit 31 estimates the clock frequency error in the above-described manner, for example.

Since the carrier frequency and the synchronization error (timing offset) are shifted in the same manner, an error of an amount corresponding to 10 [ppm], i.e., an error of 2.6 [GHz]×1×10⁻⁵=26[kHz], also occurs in the carrier frequency.

Thus, the frequency offset estimation unit 31 can also estimate the carrier frequency error (carrier frequency offset) from the clock frequency error.

The carrier frequency error estimated by the frequency offset estimation unit 31 is provided to the carrier frequency correction unit 32. Note that not only the carrier frequency of the uplink signal but also the carrier frequency of the downlink signal can be corrected.

Reception of the downlink signal for the above-mentioned synchronization process is performed periodically or according to need, but is performed independently from reception of the downlink signal for the beam forming process, for example.

Therefore, when the downlink signal from another base station device 1 is received for the beam foaming process, synchronization between the base station device 1b and the another base station device 1 has already been established. Therefore, it is not necessary to establish synchronization with the another base station device 1 each time the base station device 1b receives the downlink signal from the another base station device 1 for the beam forming process. Thus, the base station device 1b can easily obtain the downlink signal.

[Synchronization-Source Selecting Process]

As shown in FIG. 4, the femto BS 1b includes a synchronization control unit 40 that controls the timing to perform over-the-air synchronization, and performs a synchronization-source selecting process.

The synchronization control unit 40 causes the synchronization processing unit 30 to execute over-the-air synchronization periodically or irregularly according to need. While the synchronization processing unit 30 executes over-the-air synchronization, the synchronization control unit 40 causes the transmission unit 13 to suspend transmission, and causes the second reception unit 12 to receive the downlink signal transmitted from the another base station device 1.

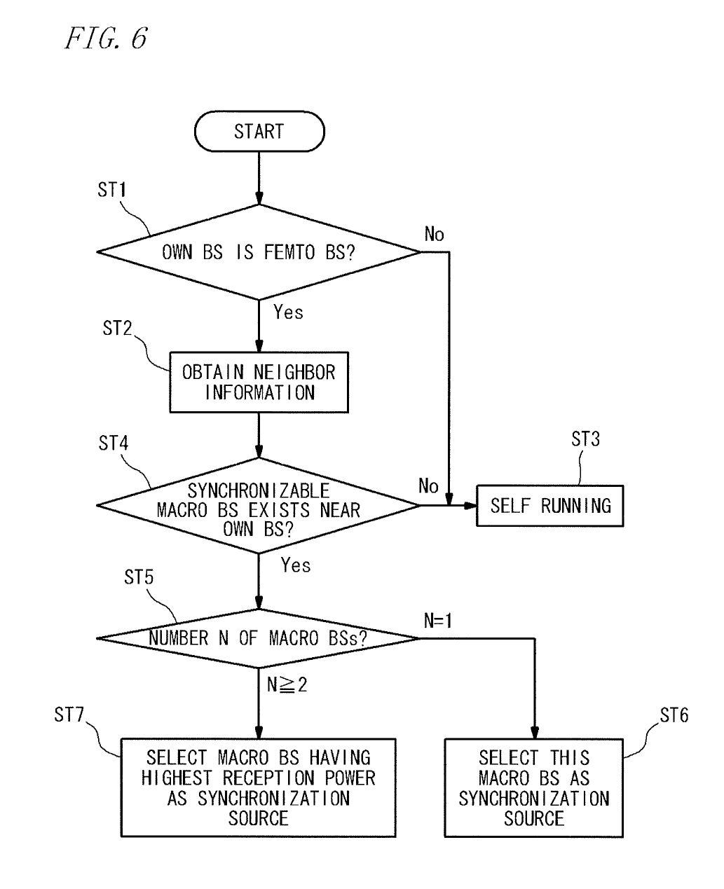

In advance of causing the synchronization processing unit 30 to execute over-the-air synchronization, the synchronization control unit 40 executes the synchronization-source selection process based on the downlink signal from the second reception unit 12. FIG. 6 is a flowchart showing the synchronization-source selection process by the synchronization control unit 40.

As shown in FIG. 6, the synchronization control unit 40 determines whether its own base station is a femto BS 1b (step ST1), and obtains neighbor information when the result of the determination is positive (step ST3). The neighbor information consists of control information and broadcast information extracted from the downlink signal (DL frame) received by the second reception unit 12.

When the result of the determination in step ST1 is negative, the synchronization control unit 40 executes a free running mode, i.e., a mode in which the synchronization control unit 40 follows its own clock frequency without causing the synchronization processing unit 30 to execute over-the-air synchronization (step ST3).

Next, the synchronization control unit 40 determines, based on the neighbor information, whether a macro BS 1a that can be synchronized with the base station device 1b exists near the base station device 1b (step ST4). Also when the result of this determination is negative, the synchronization control unit 40 executes the free running mode (step ST3).

Therefore, when only other femto BSs 1b exist near the femto BS 1b as the own base station device, the base station device 1b executes the free running mode without performing over-the-air synchronization.

The determination in step ST4, i.e., the determination as to whether the transmission source of the downlink signal is a macro BS 1a or a femto BS 1b, can be performed by using the flag information (type information) in the SIB 9 in the downlink signal, or the transmission power information in the SIB 2.

That is, when the flag included in the SIB 9 of OFF, the synchronization control unit 40 determines that the transmission-source base station device 1 is a macro BS 1a. When the flag is ON, the synchronization control unit 40 determines that the transmission-source base station device 1 is a femto BS 1b.

Alternatively, when the transmission power included in the SIB 2 is equal to or higher than a predetermined threshold, the synchronization control unit 40 determines that the transmission-source base station device 1 is a macro BS 1a. When the transmission power is lower than the threshold, the synchronization control unit 40 determines that the transmission-source base station device 1 is a femto BS 1b.

On the other hand, when the result of the determination in step ST4 is positive, the synchronization control unit 40 counts the number N of macro BS 1a (step ST5). When the number N is equal to 1, the macro BS 1a is selected as a synchronization source.

When the number N of macro BS 1a is plural (N>2), the synchronization control unit 40 selects, as a synchronization source, a macro BS 1b having the highest reception power (reception level) in the second reception unit 12 from among the N pieces of macro BS 1a.

Upon completion of the synchronization-source selecting process, the synchronization control unit 40 transmits control information of the selected synchronization source to the synchronization processing unit 30.

The synchronization processing unit 30 executes the above-mentioned over-the-air synchronization by using the downlink signal corresponding to the control information transmitted from the synchronization control unit 40.

As described above, according to the femto BS 1b of the present embodiment, the synchronization control unit 40 selects, as a synchronization source, another base station device 1, based on the identification information (the flag information in the SIB 9 or the transmission power information in the SIB 2) that can specify the scale of the communication area (cell) of the another base station device 1, which is one of identification information expressing the type of the another base station device 1.

Therefore, even when macro BSs 1a and femto BSs 1b coexist in the vicinity of the base station device 1b, it is possible to select, as a synchronization source, a macro BS 1a that is highly likely to be accurate in time. Accordingly, it is possible to form an accurate synchronization group without providing the femto BS 1b with an expensive device such as a GPS receiver.

Further, the cell of a macro BS 1a located near the base station device 1b is more likely to overlap with the cell of the base station device 1b than the cell of a femto BS 1b located near the base station device 1b. Therefore, the macro BS 1a is highly likely to cause interference due to the relationship between the base station device 1b and the macro BS 1a. That is, the identification information indicating whether the another base station device 1 is a macro BS 1a or a femto BS 1b configures information indicating whether interference can occur due to the relationship between the own base station device and the another base station device.

Accordingly, the femto BS 1b of the present embodiment selects another base station device 1 as a synchronization source based on the above-mentioned identification information. Therefore, the femto BS 1b can achieve synchronization with a base station device 1 that can cause interference. As a result, the femto BS 1b can favorably perform a process for avoiding interference.

Further, when a macro BS 1a that can be synchronized with the femto BS 1b does not exist near the femto BS 1b, the femto BS 1b executes the free running mode (steps ST3 and ST4 in FIG. 6). Therefore, another femto BS 1b that is highly likely to be inaccurate in time is not selected as a synchronization source.

Therefore, it is possible to obviate the situation where an inaccurate synchronization group comprising only a plurality of femto BSs 1b that are inaccurate in time is formed.

Moreover, according to the femto BS 1b of the present embodiment, when there are a plurality of macro BSs 1a that can be synchronization sources, a macro BS 1a that transmits a downlink signal having the highest reception intensity is preferentially selected as a synchronization source from among the macro BSs 1a (step ST7 in FIG. 6). Therefore, the synchronization process in the base station device 1b can be performed more accurately and reliably.

[Modifications]

In the above-mentioned embodiment, when no macro BS 1a exists in the vicinity of the base station device 1b, the base station device 1b executes the free running mode so as not to be synchronized with another base station device. However, since a femto BS 1b adopting a macro BS 1a as a direct synchronization source is considered to have approximately the same time accuracy as the macro BS 1a, such a femto BS 1b may be selected as a synchronization source.

Determination as to whether another base station device is a femto BS 1b adopting a macro BS 1a as a direct synchronization source can be performed by the following method (1) or (2).

(1) When over-the-air synchronization has been performed, information indicating the type of the synchronization-source device is stored in one of the SIBs in the PDSCH, and a femto BS 1b whose synchronization-source device type is a macro BS 1a is regarded as selectable as a synchronization source.

(2) Each femto BS 1b is provided with a function of autonomously generating information indicating the hierarchy of over-the-air synchronization from combinations of the primary and secondary synchronization channels (for example, refer to Japanese Patent Application No. 2009-85727), and a femto BS 1b whose order in the hierarchy is “1” is regarded as selectable as a synchronization source.

Further, in the above-mentioned embodiment, information required for over-the-air synchronization is obtained from the downlink signal received by the second reception unit 12. However, the information may be obtained by using a backhaul line that connects the plurality of base station devices 1 via a cable.

In this case, information required for the over-the-air synchronization process and the synchronization-source selecting process may be included in information to be exchanged among the base station devices 1 via the backhaul line.

Moreover, in the above-mentioned embodiment, a femto BS 1b is described as an example of a small base station. However, the small base station may be the above-mentioned pico base station.

### 2. Second Embodiment

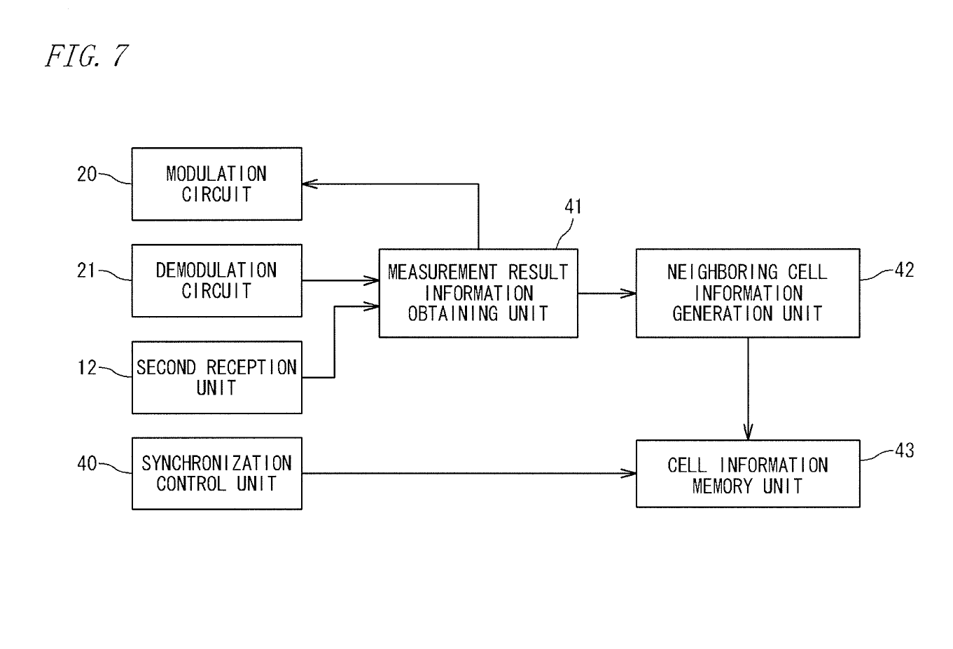

FIG. 7 is a block diagram showing a part of the internal configuration of a femto BS 1b according to a second embodiment of the present invention. The configuration of a macro BS 1a is substantially the same as that of the femto BS 1b.

The present embodiment is different from the first embodiment in the following points. That is, the femto BS 1b includes: a measurement result information obtaining unit 41 that obtains measurement result information indicating a result of measurement of a downlink signal of a base station device 1 other than its own base station device 1b1; a neighboring cell information generation unit 42 that generates, based on the measurement result information obtained by the measurement result information obtaining unit 41, neighboring cell information in which measurement result information of another cell (another base station device 1) neighboring on the base station device 1 is registered; and a cell information memory unit 43 that stores the generated neighboring cell information. The synchronization control unit 40 selects a base station device 1 to be a synchronization source in accordance with the measurement result information included in the neighboring cell information, and performs over-the-air synchronization.

The measurement result information obtaining unit 41 has a function of transmitting a measurement start request that causes an MS 2 communicably connected to the base station device 1b1 to execute measurement of the downlink signal of the another base station device 1, via the modulation circuit 20 and the transmission unit 13 to the MS 2.

Further, the measurement result information obtaining unit 41 has a function of obtaining measurement result information from a measurement result transmitted by the MS 2 that has performed measurement based on the measurement start request. Moreover, the measurement result information obtaining unit 41 has a function of measuring the downlink signal of the another base station device, which has been received by the second reception unit 12, and obtaining measurement result information from the measurement result.

The neighboring cell information generation unit 42 generates neighboring cell information based on the measurement result information obtained by the measurement result information obtaining unit 41, and outputs the neighboring cell information to the cell information memory unit 43. The neighboring cell information includes measurement result information such as the reception level and the carrier wave frequency of the downlink signal of the another base station device 1. More specifically, the neighboring cell information is generated as a table in which a unique cell ID given to each of other base station devices 1 is registered, and the reception level and the carrier wave frequency of the downlink signal of the another base station device 1 included in the measurement result information are associated with the cell ID of the corresponding another base station device 1.

The cell information memory unit 43 has a function of storing the neighboring cell information outputted from the neighboring cell information generation unit 42, and updating the neighboring cell information each time new neighboring cell information is outputted.

When the synchronization control unit 40 of the present embodiment determines execution of over-the-air synchronization periodically or irregularly according to need, the synchronization control unit 40 firstly refers to the neighboring cell information stored in the cell information memory unit 43. Then, the synchronization control unit 40 selects a base station device 1 to be a synchronization source, based on the measurement result information included in the neighboring cell information. Then, the synchronization control unit 40 performs over-the-air synchronization based on the downlink signal of the selected base station device 1. Note that the over-the-air synchronization is performed in the same procedure as described for the first embodiment.

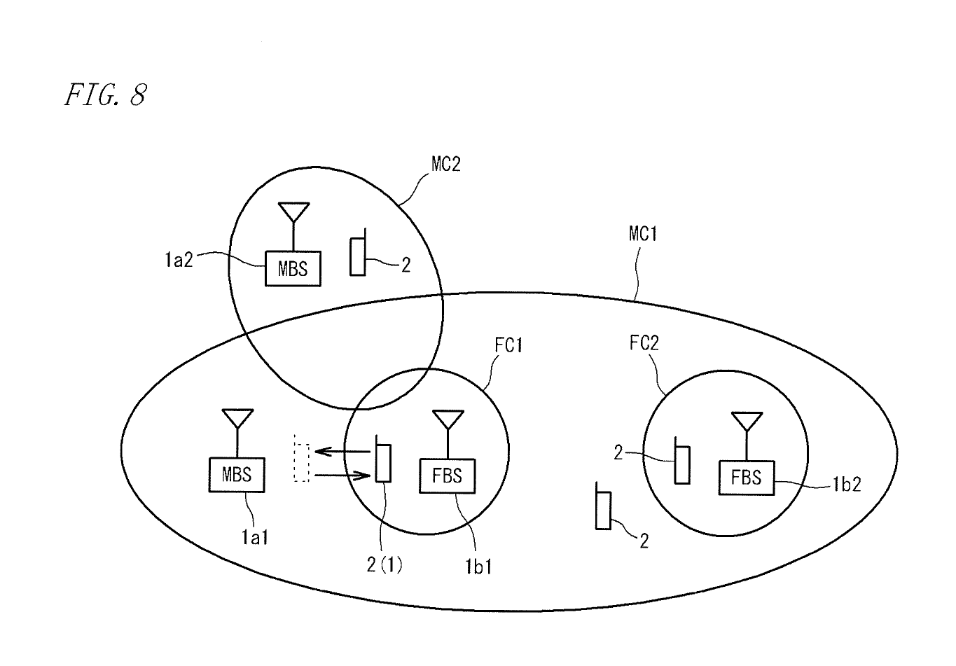

FIG. 8 is a diagram showing an example of an arrangement of the femto BS 1b according to the present embodiment in a wireless communication system. In the wireless communication system shown in FIG. 8, two macro BSs 1a1 and 1a2 and two femto BSs 1b1 and 1b2 are arranged. The femto BSs 1b1 and 1b2 form femto cells FC1 and FC2, respectively, in a macro cell MC1 formed by the macro BS 1a1. The femto cells FC1 and FC2 are formed so as not to overlap with each other. The femto cell FC1 is formed so as to overlap with a region where the macro cell MC1 and the macro cell MC2 overlap with each other.

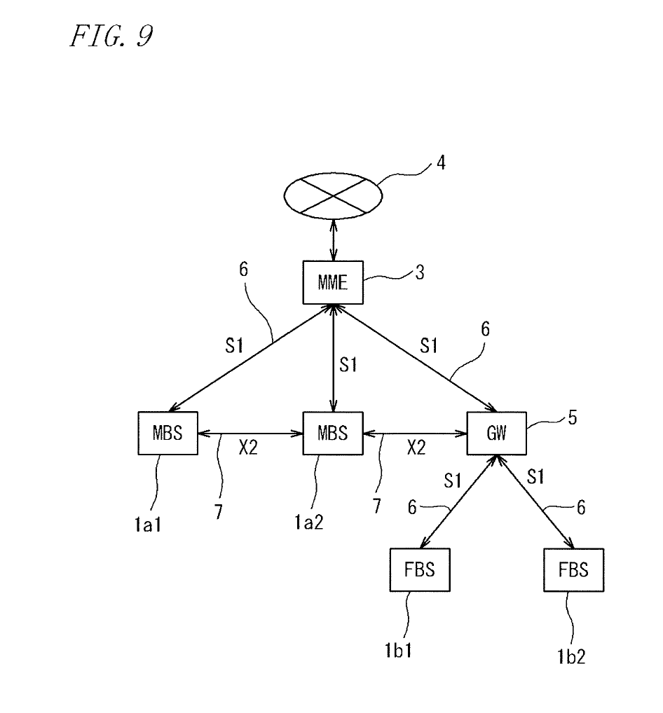

FIG. 9 is a diagram illustrating a mode of connection of the respective BSs to a communication network. Each macro BS 1a is connected to a communication network 4 of the wireless communication system via an MME (Mobility Management Entity) 3. The MME 3 is a node that manages the position and the like of each MS 2, and performs a process relating to mobility management for each MS2 by handover or the like.

Each femto BS 1b is connected to the MME 3 via a gateway 5 (GW). The gateway 5 has a function of relaying communication performed between each femto BS 1b and the MME 3, and communication performed between the femto BSs 1b.

Connection between the MME 3 and each macro BS 1a, connection between the MME 3 and the gateway 5, and connection between the gateway 5 and each femto BS 1b are each achieved by a line 6 of a communication interface called “S1 interface”.

Further, the macro BSs 1a are connected to each other by a line 7 of an inter-base-station communication interface called “X2 interface”, which allows inter-base-station communication for direct information exchange between the base station devices. Further, the gateway 5 is also connected to the macro BS 1a by the line 7 of the X2 interface.

The X2 interface is provided for the purpose of exchanging information relating to mobility management such as handover in each MS 2 that moves between the base station devices. Although such function overlaps with the function of the MME 3, the X2 interface for communication between the base station devices is provided for the following reasons. That is, if the MME 3 performs mobility management for all the MSs 2 connected to the respective macro BSs 1a, an enormous amount of processing concentrates on the MME 3. In addition, mobility management can be performed more efficiently among the base station devices.

A plurality of methods are considered for inter-base-station communication by the X2 interface, such as a method in which the base station devices are directly connected, and a method in which the base station devices are connected via the gateway.

As shown in FIG. 9, a direct communication line of the X2 interface is not established between the femto BS 1b and another base station device 1. Accordingly, the present embodiment adopts a method in which the femto BS 1b performs inter-base-station communication with the another base station device 1 by the X2 interface, via the communication line 6 of the S1 interface that connects the femto BS 1b to the gateway 5, and the gateway 5.

Note that, in FIG. 9, the macro BS 1a directly connected to the MME 3 may sometimes be referred to as “eNB (Evolved Node B)”, the gateway 5 as “Home-eNB Gateway”, and the femto BS 1b as “Home-eNB”.

Next, a description will be given of a manner in which the femto BS 1b of the present embodiment obtains the measurement result information to generate or update the neighboring cell information. In the following description, attention is focused on the femto BS 1b1 in FIG. 8, and its function and operation will be described.

[Obtainment of Measurement Result Information]

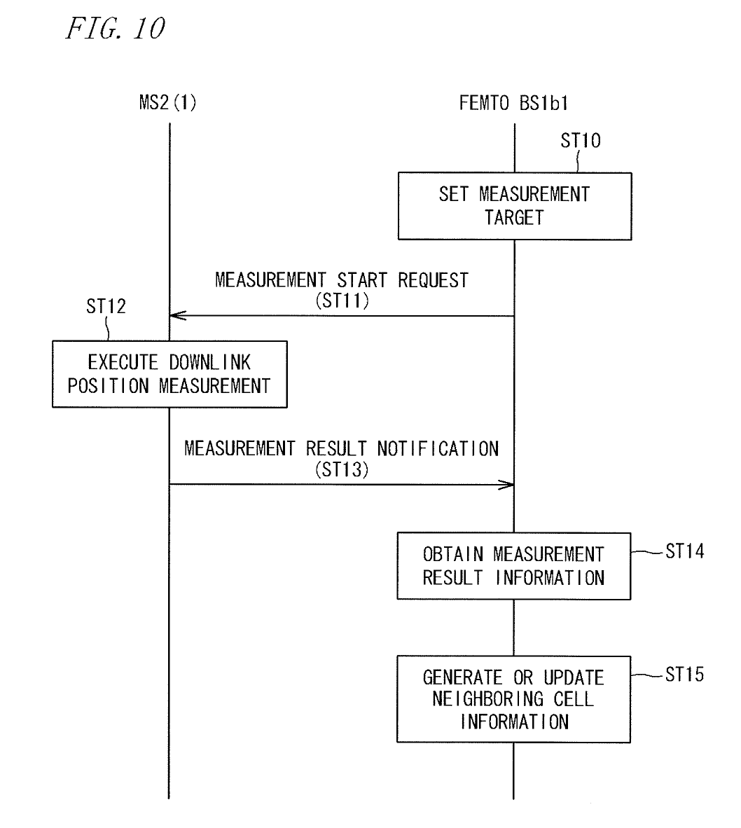

FIG. 10 is a sequential diagram showing an example of process steps when the femto BS 1b1 of the present embodiment obtains measurement result information. FIG. 10 shows a case in which the femto BS 1b1 causes the MS 2(1) to measure a downlink signal of a base station device 1 neighboring on the MS 2(1) in FIG. 8.

Firstly, the femto BS 1b1 that has determined to obtain measurement result information sets a measurement target to be measured by the MS 2(1) (step ST10).

When the femto BS 1b1 does not have neighboring cell information, such as when the femto BS 1b1 is started up, the femto BS 1b1 causes the MS 2(1) to perform all-frequency search. For example, in LTE, after startup of the femto BS 1b1, when the MS 2(1) has established RRC (Radio Resource Control) connection with the femto BS 1b1, i.e., when the MS 2(1) has completed the process for establishing communication connection with the femto BS 1b1, the femto BS 1b1 causes the MS 2 to perform all-frequency search. The all-frequency search means that the reception levels of downlink signals from other base station devices 1 are measured with respect to all types (all bands) of carrier wave frequencies set in the wireless communication system.

Accordingly, when the femto BS 1b1 has no neighboring cell information, the femto BS 1b1 sets the measurement target to all frequencies, in step ST10.

On the other hand, when the femto BS 1b1 has neighboring cell information, the femto BS 1b1 may set the measurement target to a downlink signal of another base station device specified by the neighboring cell information, or may set the measurement target to all frequencies, according to the situation.

Next, the femto BS 1b1 transmits, to the MS 2(1), a measurement start request that causes the MS 2(1) to measure the downlink signal of the another base station device 1 that is set as the measurement target (step ST11). This measurement start request includes information of the frequency and the base station device as the measurement target.

Upon receipt of the measurement start request from the femto BS 1b1, the MS 2(1) executes downlink-signal measurement for the measurement target indicated by the measurement start request (step ST12).

In step ST12, the MS 2(1) detects the downlink signal of the another base station device 1, and measures the carrier wave frequency and the reception level of the detected downlink signal. Further, the MS 2(1) obtains the cell ID of the base station device 1 that is the transmission source of the detected downlink signal.

After the downlink-signal measurement, the MS 2(1) transmits, to the femto BS 1b1, measurement result notification including the carrier wave frequency of the detected downlink signal, the reception level thereof, and the corresponding cell ID (step ST13).

Upon receipt of the measurement result notification from the MS 2(1), the femto BS 1b1 obtains measurement result information based on the measurement result notification (step ST14).

When the femto BS 1b1 has no neighboring cell information, the femto BS 1b1 generates neighboring cell information based on the obtained measurement result information (step ST15). When the femto BS 1b1 has neighboring cell information, the femto BS 1b1 updates the stored neighboring cell information based on the obtained measurement result information (step ST15).

The femto BS 1b1 executes the above-mentioned process of obtaining measurement result information periodically or irregularly according to need. Further, the femto BS 1b1 executes this process also when it performs handover described later.

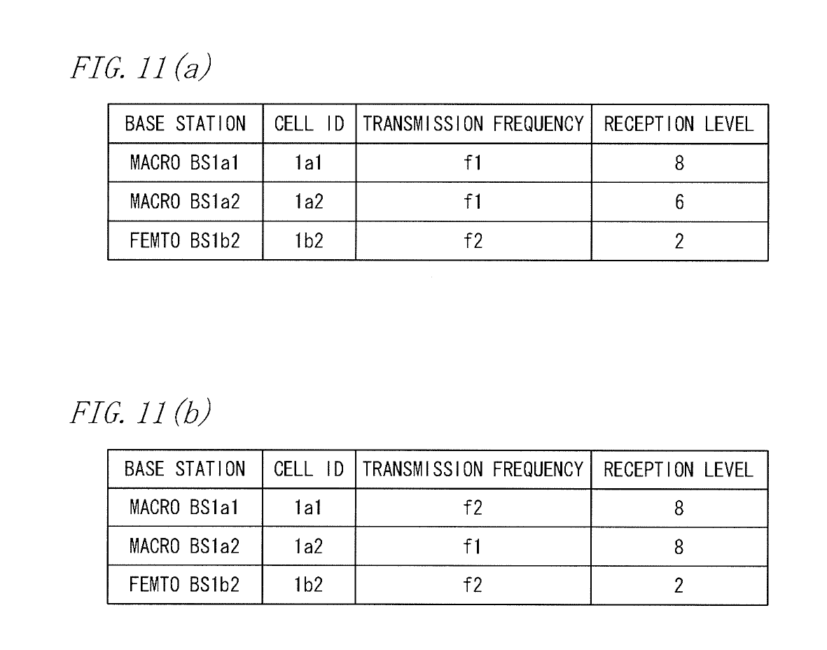

FIG. 11(a) is a diagram showing an example of neighboring cell information stored in the femto BS 1b1. In FIG. 11(a), the cell ID of the macro BS 1a1 is “1a1” and the carrier wave frequency thereof is “f1”, the cell ID of the macro BS 1a2 is “1a2” and the carrier wave frequency thereof is “f1”, and the cell ID of the femto BS 1b2 is “1b2” and the carrier wave frequency thereof is “f2”.

As shown in FIG. 11(a), in the neighboring cell information, the cell IDs of the detected other base station devices 1 (cells) are registered, and the carrier wave frequencies and the reception levels as the measurement result information are registered in association with the respective cell IDs.

The macro BS 1a1, the macro BS 1a2, and the femto BS 1b2 exist in the vicinity of the femto BS 1b1. Therefore, when the femto BS 1b1 performs the process of obtaining measurement result information, the MS 2(1) might detect the downlink signals from these BSs.

Accordingly, when the cell IDs of the macro BS 1a1, the macro BS 1a2, and the femto BS 1b2 are set as described above, the femto BS 1b obtains measurement result information including the cell IDs, the carrier wave frequencies, and the reception levels of these BSs.

Furthermore, the femto BS 1b1 reflects the carrier wave frequencies and the downlink signal reception levels included in the measurement result information to the neighboring cell information as shown in FIG. 11(a).

The synchronization control unit 40 (FIG. 7) of the femto BS 1b1 of the present embodiment selects a base station device 1 to be a synchronization source in accordance with the measurement result information included in the neighboring cell information. Then, the synchronization control unit 40 performs over-the-air synchronization based on the downlink signal of the selected base station device 1.

More specifically, the synchronization control unit 40 selects a base station device 1 having the highest reception level included in the measurement result information, from among the other base station devices 1 registered in the neighboring cell information.

For example, it is assumed that the neighboring cell information is in the state shown in FIG. 11(a) when the synchronization control unit 40 determines to execute over-the-air synchronization and therefore refers to the neighboring cell information stored in the cell information memory unit 43. In this case, the synchronization control unit 40 selects, as a synchronization source, the macro BS 1a1 having the highest reception level.

That is, the closer the positions of neighboring two base station devices 1 are to each other, the higher the possibility that a downlink signal of one of the base station devices 1 causes interference to an MS 2 connected to the other base station device 1.

Further, the higher the reception level of the downlink signal of the another base station device 1, which is obtained by the femto BS 1b1 of the present embodiment, the higher the possibility that the another base station device 1 is located near the femto BS 1b1. That is, the information relating to the reception level of the another base station device 1 configures information whose value is influenced by the positional relationship between the base station device 1b1 and the another base station device 1.

According to the present embodiment, a base station device 1 having the highest reception level of a downlink signal is selected as a synchronization source from among the detected other base station devices 1. Therefore, it is possible to select, as a synchronization source, another base station device 1 that can be determined as being located relatively near the base station device 1b1 and being highly likely to cause interference. As a result, the base station device 1b1 can achieve synchronization with the another base station device 1 that is highly likely to cause interference, and can favorably perform the process for avoiding interference.

Furthermore, in the present embodiment, the synchronization control unit 40 selects another base station device 1 to be a synchronization source, based on the reception level of the downlink signal of the another base station device 1, among the measurement results included in the neighboring cell information. However, as a modification of the present embodiment, the synchronization control unit 40 may select another base station device 1 to be a synchronization source, based on the carrier wave frequency of the downlink signal of the another base station device 1, among the measurement results included in the neighboring cell information.

### First Modification of the Second Embodiment

FIG. 11(b) is a diagram showing an example of neighboring cell information stored in the femto BS 1b1 according to a first modification of the second embodiment. In FIG. 11(b), the carrier wave frequency of the downlink signal of the macro BS 1a1 is “f2” and the reception level thereof is “8”, and the carrier wave frequency of the macro BS 1a2 is “f1” and the reception level thereof is “8”. In this case, the macro BSs 1a1 and 1a2 have the same reception level, and different carrier wave frequencies.

When the carrier wave frequency of the base station device 1b1 is “f1”, the synchronization control unit 40 selects, as a synchronization source, the macro BS 1a2 whose carrier wave frequency is equal to that of the base station device 1b1 although the macro BSs 1a1 and 1a2 have the same reception level. That is, in this case, the synchronization control unit 40 is configured to preferentially select another base station device 1 whose carrier wave frequency is equal to that of the base station device 1b1.

That is, when two base station devices 1 use different carrier wave frequencies, the possibility of interference between these base station devices 1 is low. However, when two base station devices 1 use the same carrier wave frequency, the possibility that the downlink signal of one of these base station devices 1 causes interference to an MS 2 connected to the other base station device 1 becomes high. That is, the carrier wave frequency of another base station device 1 configures information indicating whether interference can occur due to the relationship between the base station device 1b1 and the another base station device 1.

In this regard, the synchronization control unit 40 according to this modification preferentially selects another base station device 1 whose carrier wave frequency is the same as that of the base station device 1b1, and therefore, can select, as a synchronization source, another base station device 1 that is highly likely to cause interference. As a result, it is possible to achieve synchronization with the another base station device 1 that is highly likely to cause interference, and thus the process for avoiding interference can be favorably performed.

Alternatively, the measurement result information obtaining unit 41 may obtain measurement result information including the detection results of other base station devices 1, and the synchronization control unit 40 may select a base station device 1 to be a synchronization source, based on the detection results of the other base station devices 1 obtained as the measurement result information.

### Second Modification of the Second Embodiment

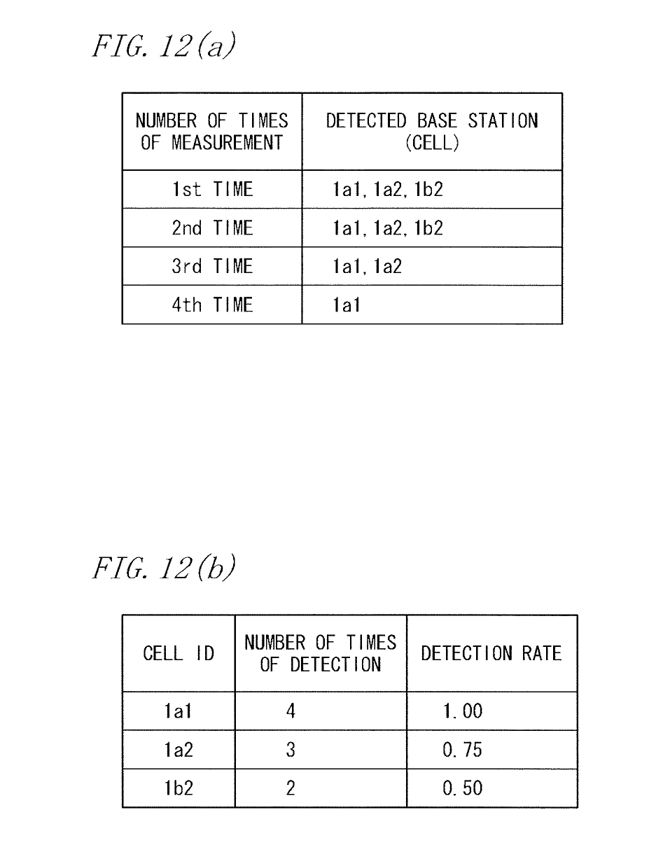

FIG. 12(a) is a diagram showing an example of a detection result of other base station devices 1 detected when a femto BS 1b according to a second modification of the second embodiment obtains measurement result information. FIG. 12(b) is a diagram showing an example of neighboring cell information generated by a neighboring cell information generation unit 42 according to the second modification, based on the detection result shown in FIG. 12(a).

The measurement result information obtaining unit 41 according to the second modification is configured to count the number of times another base station device 1 is detected within a predetermined time period, based on a measurement result notification transmitted each time an MS 2 performs downlink-signal measurement, and obtain the number of times of detection and the detection rate as measurement result information.

Further, as shown in FIG. 12(b), the neighboring cell information generation unit 42 generates neighboring cell information in which the number of times of detection and the detection rate included in the measurement result information are associated with the cell ID of the corresponding base station device 1.

Each time the measurement result information obtaining unit 41 executes obtainment of measurement result information, the measurement result information obtaining unit 41 receives, from the MS 2, a measurement result notification including the cell IDs of other base station devices 1 that are detected by downlink-signal measurement.

For example, it is assumed that the measurement result information obtaining unit 41 executes obtainment of measurement result information four times in a predetermined time period, and the detection result of other base station devices 1 by the downlink-signal measurement at each execution is as shown in FIG. 12(a). In this case, in the first downlink-signal measurement, the measurement result information obtaining unit 41 receives, from the MS 2, measurement result notification including the cell IDs of the detected macro BS 1a1, macro BS 1a2, and femto BS 1b2. Similarly in the second and subsequent downlink-signal measurements, the measurement result information obtaining unit 41 receives a notification including the detection result of other base station devices 1.

The measurement result information obtaining unit 41 can recognize that the base station devices 1 corresponding to the cell IDs included in the measurement result information have been detected as the result of the downlink-signal measurement. Accordingly, each time the measurement result information obtaining unit 41 executes obtainment of measurement result information, the measurement result information obtaining unit 41 counts, for each base station device 1, the number of times the base station device 1 is detected. Further, the measurement result information obtaining unit 41 calculates, as a detection rate, the ratio of the number of times of detection to the number of times of downlink-signal measurement.

For example, as shown in FIG. 12(a), the macro BS 1a1 is detected in all the four times of downlink-signal measurement. Accordingly, the measurement result information obtaining unit 41 obtains measurement result information indicating that the number of times the macro BS 1a1 is detected is “4” and the detection rate is “1.00”. The measurement result information obtaining unit 41 obtains, for each of other detected cells, the number of times of detection and the detection rate in the same manner as described above.

That is, the number of times of detection and the detection rate of each of the detected cells configure information relating to the detection result when the downlink signal of the corresponding base station device 1 is detected.

The neighboring cell information generation unit 42 receives the measurement result information obtained by the measurement result information obtaining unit 41, and generates the neighboring cell information shown in FIG. 12(b).

The synchronization control unit 40 selects another base station device 1 to be a synchronization source, based on at least either of the number of times of detection and the detection rate which are the measurement result information included in the neighboring cell information.

More specifically, the synchronization control unit 40 selects a base station device 1 having the largest number of times of detection included in the measurement result information, from among the other base station devices 1 registered in the neighboring cell information.

For example, it is assumed that the neighboring cell information is in the state shown in FIG. 12(b) when the synchronization control unit 40 determines to execute over-the-air synchronization and therefore refers to the neighboring cell information stored in the cell information memory unit 43. In this case, the synchronization control unit 40 selects, as a synchronization source, the macro BS 1a1 having the largest number of times of detection.

The larger the number of times of detection, the higher the possibility that the another base station device 1 corresponding to the number of times of detection is located near the base station device 1b1. That is, the number of times of detection of another base station device 1 configures information whose value is influenced by the positional relationship between the base station device 1b1 and the another base station device 1.

Further, as described above, between two base station devices 1 neighboring on each other, the closer the positions of these base station devices 1 are to each other, the higher the possibility that the downlink signal of one of the base station devices 1 causes interference to an MS 2 connected to the other base station device 1.

According to this modification, a base station device 1 having the largest number of times of detection is selected as a synchronization source from among the detected other base station devices 1. Therefore, it is possible to select, as a synchronization source, another base station device 1 that is determined as being near the base station device 1b1 and being highly likely to cause interference. As a result, the base station device 1b1 can achieve synchronization with the another base station device 1 that is highly likely to cause interference, and can favorably perform the process for avoiding interference.

Furthermore, like the number of times of detection, the larger the detection rate, the higher the possibility that another base station device 1 corresponding to the detection rate is located near the base station device 1b1.

Accordingly, while in the above-mentioned modification the synchronization control unit 40 selects a synchronization source in accordance with the number of times of detection, the synchronization control unit 40 may selects, as a synchronization source, a base station device 1 having the largest detection rate included in the measurement result information, from among the other base station devices 1 registered in the neighboring cell information.

Further, the femto BS 1b1 of this modification may be configured such that the synchronization control unit 40 selects another base station device 1 to be a synchronization source in accordance with both the number of times of detection and the detection rate. In this case, for example, selection according to the number of times of detection may be preferentially performed, and if selection according to the number of times of detection cannot be performed because, for example, two base station devices 1 have the same number of times of detection, selection according to the detection rate may be performed.

Alternatively, the measurement result information obtaining unit 41 may obtain measurement result information including the detection times at which the other base station devices 1 was detected, and the synchronization control unit 40 may select a base station device 1 to be a synchronization source in accordance with the detection times of the other base station devices 1, which are obtained as the measurement result information.

### Third Modification of the Second Embodiment

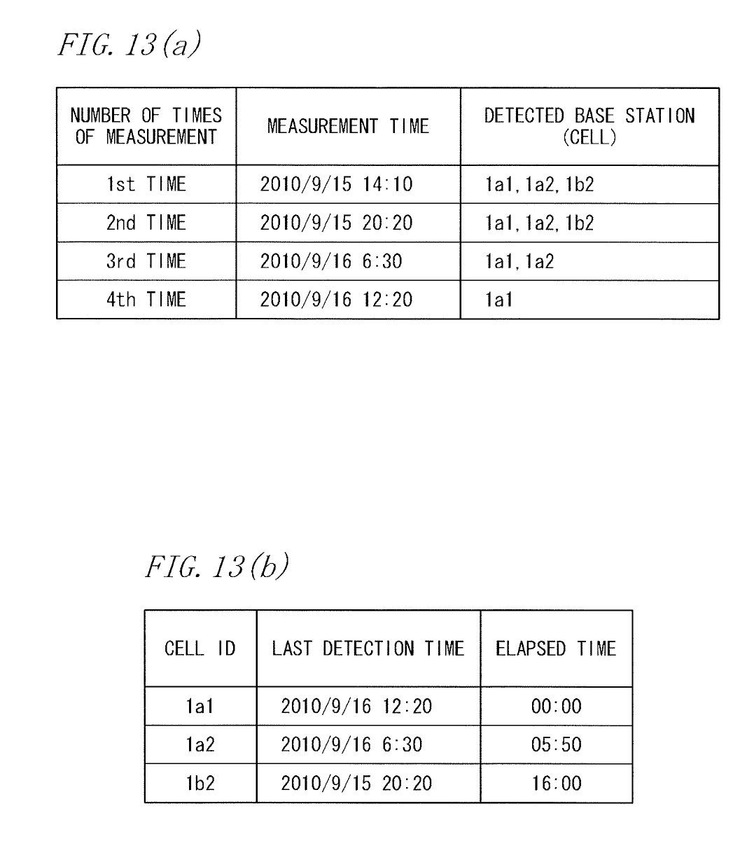

FIG. 13(a) is a diagram illustrating an example of a detection result of other base station devices 1 detected when a femto BS 1b according to a third modification of the second embodiment obtains measurement result information. FIG. 13(b) is a diagram illustrating an example of neighboring cell information generated by the neighboring cell information generation unit 42 of this modification, based on the detection result shown in FIG. 13(a).

The measurement result information obtaining unit 41 of this modification is configured to obtain, based on the measurement result notification that is transmitted each time the MS 2 performs downlink-signal measurement, the last detection time of each of the other base station devices 1 (the time at which a downlink signal of the base station device 1 has been detected most recently), and the elapsed time from the last detection time to the present time, as measurement result information.

Further, as shown in FIG. 13(b), the neighboring cell information generation unit 42 generates neighboring cell information in which the last detection times and the elapsed times included in the measurement result information are associated with the cell IDs of the corresponding other base station devices 1.

Each time the measurement result information obtaining unit 41 executes obtainment of measurement result information, the measurement result information obtaining unit 41 obtains, from the MS 2, a measurement result notification including the cell IDs of other base station devices 1 detected by downlink-signal measurement, and the measurement time at the detection.

For example, it is assumed that the measurement result information obtaining unit 41 executes obtainment of measurement result information four times at predetermined timings, and the detection result of other base station devices 1 by downlink-signal measurement at each execution is as shown in FIG. 13(a). In this case, in the first downlink-signal measurement, the measurement result information obtaining unit 41 receives, from the MS 2, a measurement result notification including the cell IDs of the detected macro BS 1a1, macro BS 1a2, and femto BS 1b2, and the measurement time at the detection, i.e., “Sep. 15, 2010 14:10”. Similarly in the second and subsequent downlink-signal measurements, the measurement result information obtaining unit 41 receives a notification including the detection result of other base station devices 1.

The measurement result information obtaining unit 41 can recognize that the base station devices 1 of the cell IDs included in the measurement result information have been detected as the result of the downlink-signal measurement. Further, the measurement result information obtaining unit 41 can also recognize the measurement time at the detection. Accordingly, each time the measurement result information obtaining unit 41 executes obtainment of measurement result information, the measurement result information obtaining unit 41 updates, for each of other base station devices 1, the last detection time at which the base station device 1 has been detected most recently. Further, the measurement result information obtaining unit 41 obtains the elapsed time from the last detection time to the present time.

For example, assuming that the present time is “Sep. 16, 2010 12:20”, the measurement time at which the macro BS 1a1 has been detected most recently is, as shown in FIG. 13(a), the same as the present time, i.e., “Sep. 16, 2010 12:20”. Accordingly, the measurement result information obtaining unit 41 obtains measurement result information indicating that the last detection time of the macro BS 1a1 is “Sep. 16, 2010 12:20”, and the elapsed time is “00:00”. The measurement result information obtaining unit 41 obtains, for each of other detected cells, the last detection time and the elapsed time in the same manner as described above.

The neighboring cell information generation unit 42 receives the measurement result information obtained by the measurement result information obtaining unit 41, and generates neighboring cell information shown in FIG. 13(b).

The synchronization control unit 40 selects a base station device 1 to be a synchronization source, based on at least either of the last detection time and the elapsed time which are the measurement result information included in the neighboring cell information.

More specifically, the synchronization control unit 40 selects a base station device 1 having the shortest elapsed time (a base station device having been detected at a time closest to the present time) included in the measurement result information, from among the other base station devices 1 registered in the neighboring cell information.

For example, it is assumed that the neighboring cell information is in the state shown in FIG. 13(b) when the synchronization control unit 40 determines to execute over-the-air synchronization and therefore refers to the neighboring cell information stored in the cell information memory unit 43. In this case, the synchronization control unit 40 selects, as a synchronization source, the macro BS 1a1 having the shortest elapsed time.

The longer the elapsed time, the higher the possibility that another base station device 1 does not exist in the vicinity of the base station device 1b1. The reason is as follows. When the elapsed time is long, it is considered that another base station device 1 to be a target has moved away from the base station device 1b1, or is powered off and is not running.

Conversely, the shorter the elapsed time, the higher the possibility that another base station device 1 exists in the vicinity of the base station device 1b1.

According to this modification, a base station device 1 having the shortest elapsed time is selected as a synchronization source from among the detected other base station devices 1. Therefore, it is possible to select, as a synchronization source, another base station device 1 that is highly likely to exist in the vicinity of the base station device 1b1. As a result, the base station device 1b1 can reliably achieve synchronization with the another base station device 1 that is highly likely to exist in the vicinity of the base station device 1b1, and can favorably perform the process of avoiding interference.

While in the above-mentioned modification the synchronization control unit 40 selects a synchronization source in accordance with the elapsed time, the synchronization control unit 40 may select a synchronization source in accordance with the last detection time.

### Other Modifications of the Second Embodiment

In the above-mentioned embodiment, the femto BS 1b causes the MS 2(1) to measure the downlink signal from the neighboring base station device 1 to obtain the measurement result information. However, the femto BS 1b1 may cause its own second reception unit 12 to measure a downlink signal from another base station device 1, and may obtain measurement result information from the result of the measurement.

Further, in the above-mentioned embodiment, the position of another base station device 1 with respect to the base station device 1b1 is estimated based on the reception level that is information indicating the positional relationship between the base station device 1b1 and the another base station device 1, and a base station device 1 that is located near the base station device 1b1 and is highly likely to cause interference is specified and selected as a synchronization source. However, if each base station device 1 is provided with a GPS function or the like and thereby can grasp its own position, the femto BS 1b1 may obtain positional information indicating the position of another base station device 1 directly from the another base station device 1, and may select a base station device 1 nearest to the femto BS 1b1, based on the positional information.

In this case, since the respective base station devices 1 can perform inter-base-station communication via the X2 interface, the femto BS 1b1 can obtain the positional information of each base station device 1 by the inter-base-station communication.

Further, when the respective base station devices 1 can perform inter-base-station communication via the X2 interface, the base station devices 1 can easily exchange information such as their positions and carrier wave frequencies, and thus the process of avoiding interference can be favorably performed.

Accordingly, the base station device 1b1 may obtain, from another base station device 1, information indicating whether inter-base-station communication via the X2 interface can be performed between the base station device 1b1 and the another base station device 1, and may generate neighboring cell information in which this information is registered.

In this case, when the synchronization control unit 40 of the femto BS 1b1 selects another base station device 1 to be a synchronization source, the synchronization control unit 40 can preferentially select a base station device 1 capable of performing inter-base-station communication via the X2 interface with the base station device 1b1 over a base station device 1 that is not capable of performing such inter-base-station communication. As a result, the femto BS 1b1 can select another base station device 1 that can favorably perform the process of avoiding interference.

In this way, the information indicating whether inter-base-station communication via the X2 interface can be performed between the base station device 1b1 and another base station device 1 configures information indicating whether it is possible to avoid interference caused by the relationship between the base station device 1b1 and the another base station device 1.

Further, in the above-mentioned embodiment, if another base station device 1 that is powered off and is not running is selected as a synchronization source, over-the-air synchronization cannot be normally performed. Therefore, it is preferable that another base station device 1 that is powered off is excluded from choices as synchronization sources. Furthermore, if another base station device 1 is powered off, no interference occurs between the base station device 1b1 and the another base station device 1.

Accordingly, the base station device 1b1 may obtain information indicating the power ON/OFF state of another base station device 1, and generate neighboring cell information in which this information is registered.

Thereby, the femto BS 1b1 can reliably perform synchronization, and select another base station device 1 that is likely to cause interference. As a result, the femto BS 1b1 can achieve synchronization with the another base station device 1 that is likely to cause interference, and thereby can favorably perform the process of avoiding interference.

In order to grasp whether another base station device 1 is powered off, the femto BS 1b1 may obtain information indicating the power ON/OFF state of the another base station device 1 from a superordinate device such as the MME 3 or the gateway 5. Alternatively, the femto BS 1b1 may obtain the information indicating the power ON/OFF state of another base station device 1 by inter-base-station communication via the X2 interface.

### 3. Third Embodiment

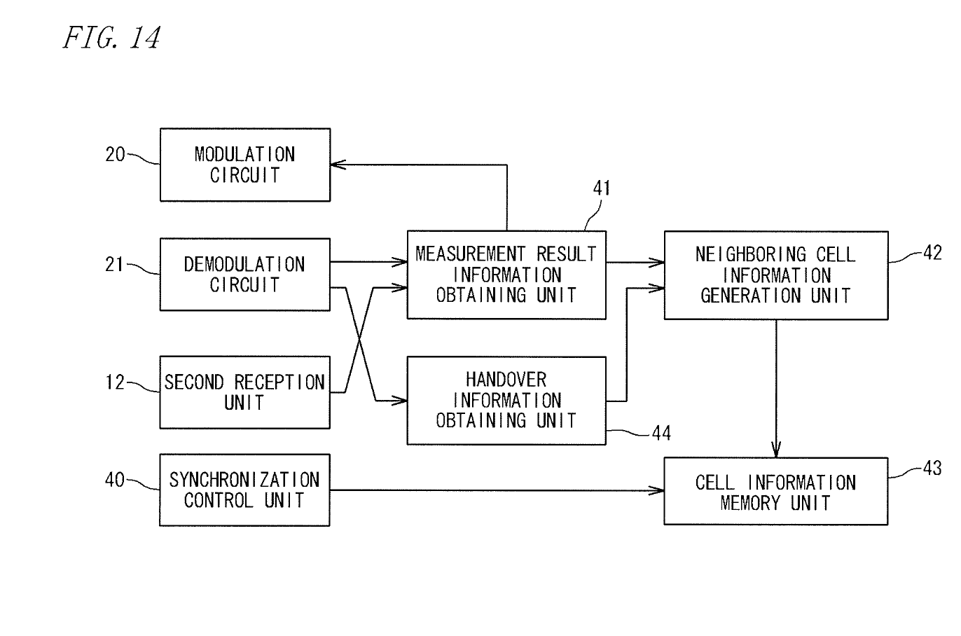

FIG. 14 is a partial block diagram showing a part of an internal configuration of a femto BS 1b according to a third embodiment of the present invention. The configuration of a macro BS 1a is substantially the same as that of the femto BS 1b.

The present embodiment is different from the second embodiment in the following points. That is, the femto BS 1b1 includes a handover information obtaining unit 44 that obtains handover information relating to handover performed by an MS 2 that is communicably connected to the femto BS 1b1. The neighboring cell information generation unit 42 generates and updates neighboring cell information in which the handover information is associated with a cell ID of another base station device 1 as a handover target. The synchronization control unit 40 selects another base station device 1 as a synchronization source in accordance with the handover information.

The handover information includes the number of trials of handover, the number of successes of handover, and the handover success rate, which are obtained when the MS 2 connected to the femto BS 1b1 performs handover.

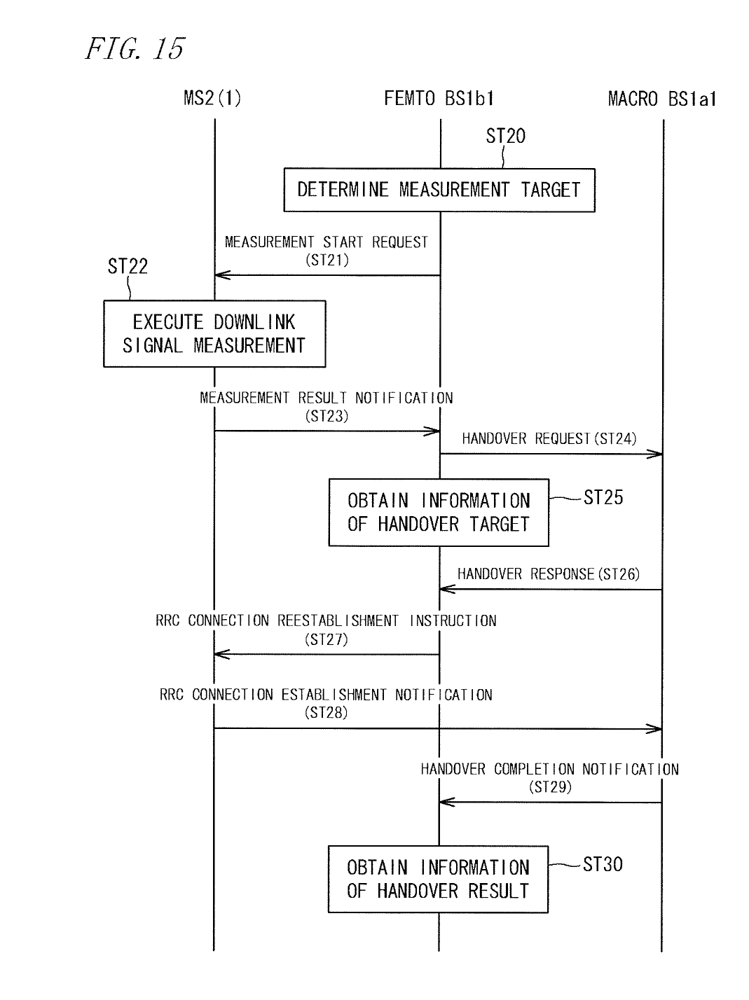

FIG. 15 is a sequential diagram showing an example of a manner in which the femto BS 1b1 obtains handover information during handover performed between the femto BS 1b1 and the MS 2. Note that FIG. 15 shows a case where the MS 2(1) connected to the femto BS 1b1 in FIG. 8 performs handover to the macro BS 1a1.

Firstly, the femto BS 1b1 executes obtainment of measurement result information to cause the MS 2(1) to perform downlink-signal measurement. Therefore, the femto BS 1b1 sets a measurement target of the MS 2(1) (step ST20). Here, the femto BS 1b1 sets the measurement target to a downlink signal of another base station device 1 registered in the neighboring cell information.

Next, the femto BS 1b1 transmits, to the MS 2(1), a measurement start request that causes the MS 2(1) to measure the downlink signal as the set measurement target (step ST21). The measurement start request includes information of the frequency and the base station device as the measurement target, and the like.

Next, the MS 2(1) receives the measurement start request from the femto BS 1b1, and executes downlink-signal measurement for the measurement target indicated by the measurement start request (step ST22).

Upon completion of the downlink-signal measurement, the MS 2(1) transmits, as a measurement result, to the femto BS 1b1, a measurement result notification including the reception level of the detected downlink signal and the corresponding cell ID (step ST23). Further, at this time, the MS 2(1) also transmits, to the femto BS 1b1, the reception level of the downlink signal of the femto BS 1b1.

Upon receipt of the measurement result notification from the MS 2(1), the femto BS 1b1 determines, based on the measurement result notification, whether the MS 2(1) should perform handover. Upon determination that the MS 2(1) should perform handover, the femto BS 1b1 determines a handover target with reference to the neighboring cell information, and transmits a handover request to the macro BS 1a1 (step ST24). In FIG. 15, the macro BS 1a1 is determined as the handover target.

The determination whether to perform handover and the determination of the handover target are performed by comparing the reception level of the downlink signal of the currently-connected base station device 1 with the reception level of the another base station device 1.

Furthermore, the determination whether to perform handover and the determination of the handover target may be performed by the MS 2(1). In this case, the femto BS 1b1 transmits a handover request in accordance with the determinations by the MS 2(1).

By transmitting the handover request, the femto BS 1b1 can recognize to which base station device 1 the MS 2(1) has tried handover. Here, the handover information obtaining unit 44 is informed that the MS 2(1) has tried handover, and obtains information relating to the determined handover target (step ST25).

Upon receipt of the handover request, the macro BS 1a1 transmits, to the femto BS 1b1, a handover response to the handover request (step ST26).

Upon receipt of the handover response, the femto BS 1b1 transmits an RRC connection reestablishment instruction to the MS 2(1) (step ST27).

When an RRC connection has been established between the MS 2(1) and the macro BS 1a1, the MS 2(1) transmits an RRC connection establishment notification to the macro BS 1a1 (step ST28).

Upon receipt of the RRC connection establishment notification, the macro BS 1a1 transmits a handover completion notification to the femto BS 1b1 (step ST29).

Upon receipt of the handover completion notification, the femto BS 1b1 releases the information relating to the MS 2(1), and ends the handover. Further, by receiving the handover completion notification, the femto BS 1b1 can recognize that the handover has succeeded. At this time, the handover information obtaining unit 44 obtains information relating to the result of the handover (step ST30).

If the handover has failed, the macro BS 1a1 transmits a handover failure notification in step ST29.

The transmission/reception of the handover request, the handover response, and the handover completion notification between the femto BS 1b1 and the macro BS 1a1 are performed via a superordinate device such as the MME 3 and the gateway 5, but may be performed by inter-base-station communication via the X2 interface.

Based on the information that handover has been tried, the information relating to the determined handover target, and the information relating to the handover result, which have been obtained in steps ST25 and ST30, the handover information obtaining unit 44 obtains the number of trials of handover, the number of successes of handover, and the handover success rate, which are handover information of each another base station device 1. The handover success rate is obtained by dividing the number of successes of handover by the number of trials of handover.

The handover information obtaining unit 44 outputs the obtained handover information to the neighboring cell information generation unit 42. Based on the handover information, the neighboring cell information generation unit 42 generates and updates neighboring cell information in which the number of trials of handover, the number of successes of handover, and the handover success rate, which are included in the handover information, are associated with the cell ID of the another base station device 1 as a handover target.

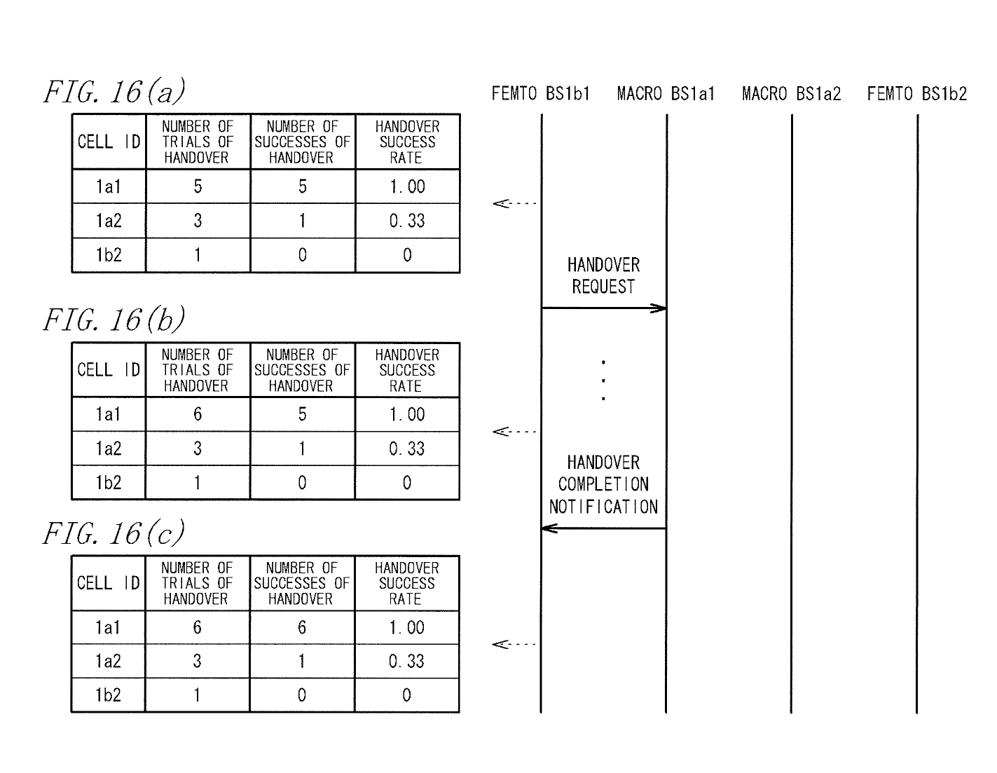

FIG. 16 is a diagram showing an example of a manner in which the femto BS 1b1 updates the neighboring cell information when handover has been performed in the procedure shown in FIG. 15. In FIG. 16, a sequential diagram of a handover operation process is shown on the right, and neighboring cell information corresponding to the handover operation process is shown on the left.

In FIG. 16, in the stage before the femto BS 1b1 transmits a handover request to the macro BS 1a1 (FIG. 16(a)), the femto BS 1b1 has tried handover nine times in a predetermined time period. That is, the neighboring cell information of the femto BS 1b1 in this stage indicates that handover from the femto BS 1b1 to the macro BS 1a1 has been tried five times in the past and the five trials have succeeded. Therefore, the handover success rate is “1.00”. Further, the neighboring cell information indicates that handover from the femto BS 1b1 to the macro BS 1a2 has been tried three times and one trial has succeeded. Therefore, the handover success rate is “0.33”. Further, the neighboring cell information indicates that handover from the femto BS 1b1 to the femto BS 1b2 has been tried three times and one trial has succeeded. Therefore, the handover success rate is “0.33”.

It is assumed that, from the above state, the femto BS 1b1 tries handover to the macro BS 1a1 as a handover target, for the MS 2(1) connected to the femto BS 1b1.

After transmitting a handover request to the macro BS 1a1, the femto BS 1b1 updates the number of trials of handover to the macro BS 1a1, in the neighboring cell information, from “5” to “6” (FIG. 16(b)).

Upon receipt of a handover completion notification from the macro BS 1a1, the femto BS 1b1 updates the number of successes of handover to the macro BS 1a1, in the neighboring cell information, from “5” to “6” (FIG. 16(c)). In this case, the handover success rate does not change and remains as it is.

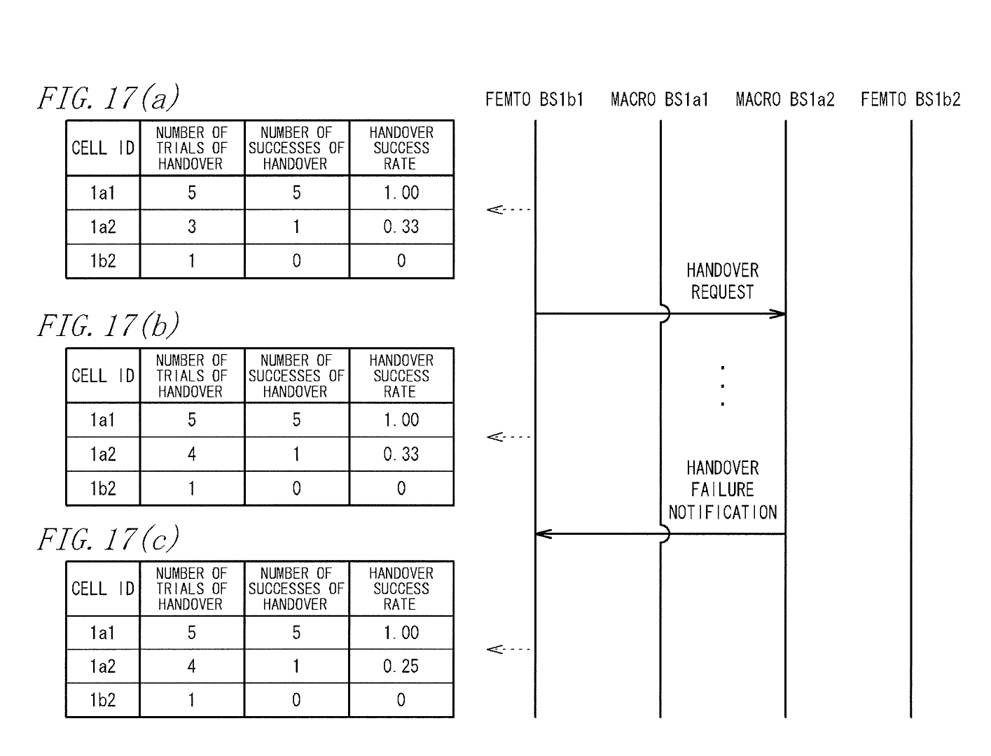

FIG. 17 is a diagram showing another example of a manner in which the femto BS 1b1 updates the neighboring cell information when handover has been performed.

In FIG. 17, in the stage before the femto BS 1b1 transmits a handover request (FIG. 17(a)), the contents of the neighboring cell information is the same as that shown in FIG. 16.

It is assumed that, from this state, the femto BS 1b1 tries handover to the macro BS 1a2 as a handover target, for the MS 2(1) connected to the femto BS 1b1.

After transmitting a handover request to the macro BS 1a2, the femto BS 1b1 updates the number of trials of handover to the macro BS 1a2, in the neighboring cell information, from “3” to “4” (FIG. 17(b)).

If the requested handover has failed, the femto BS 1b1 receives a handover failure notification from the macro BS 1a2. Thereby, the femto BS 1b1 maintains, in the neighboring cell information, the number of successes of handover to the macro BS 1a2 to be “1”, and updates the handover success rate from “0.33” to “0.25” (FIG. 17(c)).

If the femto BS 1b1 can recognize the handover source, the femto BS 1b1 may generate neighboring cell information by using not the information of the handover target but the information of the handover source.

The synchronization control unit 40 of the femto BS 1b1 of the present embodiment selects a base station device 1 to be a synchronization source, in accordance with the handover information included in the neighboring cell information. Then, the synchronization control unit 40 performs over-the-air synchronization based on a downlink signal of the selected base station device 1.

More specifically, the synchronization control unit 40 selects another base station device 1 having the largest number of trials of handover, from the handover information registered in the neighboring cell information.

For example, it is assumed that the neighboring cell information is in the state shown in FIG. 17(c) when the synchronization control unit 40 determines to execute over-the-air synchronization and therefore refers to the neighboring cell information stored in the cell information memory unit 43. In this case, the synchronization control unit 40 selects, as a synchronization source, the macro BS 1a1 having the largest number of trials of handover.

The larger the number of trials of handover, the higher the possibility that the another base station device 1 corresponding to the number of trials of handover is located near the base station device 1b1. That is, the MS 2 connected to the base station device 1b1 is determined as being highly likely to need handover, when the reception level of the another base station device 1 neighboring on the base station device 1b1 is relatively high. The reception level, when it is relatively high, indicates that the another base station device 1 is highly likely to exist near the femto BS 1b1. That is, the number of trials of handover of the MS 2 performed to the another base station device 1 configures information whose value is influenced by the positional relationship between the base station device 1b1 and the another base station device 1.

Further, the closer the positions of neighboring two base station devices are to each other, the higher the possibility that a downlink signal of one of the base station devices 1 causes interference to an MS 2 connected to the other base station device 1.

According to the present embodiment, among the other base station devices 1 located in the vicinity of the base station device 1b1, a base station device 1 having the largest number of trials of handover is selected as a synchronization source. Therefore, it is possible to select, as a synchronization source, another base station device 1 which is located near the base station device 1b1 and is highly likely to cause interference. As a result, the base station device 1b1 can achieve synchronization with the another base station device 1 that is highly likely to cause interference, and can favorably perform the process of avoiding interference.

While the femto BS 1b1 of the present embodiment selects a synchronization source based on only the number of trials of handover, the femto BS 1b1 may select a synchronization source in view of the number of successes of handover or the handover success rate in addition to the number of trials of handover. In this case, for example, selection according to the number of trials of handover may be preferentially performed, and if selection according to the number of trials of handover cannot be performed because, for example, two base station devices 1 have the same number of trials of handover, selection according to the number of successes of handover or the handover success rate may be performed.

Further, if the handover information obtaining unit 44 can obtain the time interval between handover trials (handover interval) for each another base station device 1, another base station device 1 to be a synchronization source may be selected in accordance with the handover interval. In this case, it is preferable that another base station device 1 having the shorter handover interval is selected as a synchronization source. The reason is that, the shorter the handover interval, the larger the number of trials of handover per unit time.

### Modifications of the Third Embodiment

As information whose value is influenced by the positional relationship between the base station device 1b1 and another base station device 1, a sojourn time (an average value or the like) during which an MS 2 connected to the base station device 1b1 stays in the cell of the base station device 1b1 may be used in addition to the number of trials of handover, the number of successes of handover, or the handover success rate. The sojourn time is a time interval (t2-t1) from time t1 at which handover has been performed to connect the MS 2 to the base station device 1b1 to time t2 at which handover is performed to connect the MS 2 to another base station device 1. The shorter the sojourn time, the more frequently handover is performed. So, the brevity of the sojourn time serves as an index similar to the frequency of handover. That is, the sojourn time is information whose value is influenced by the number of times of handover.

The sojourn time may be a time during which an MS 2 stays in another cell neighboring on the cell of the base station device 1b1. That is, the sojourn time may be a time interval from time t1 at which handover has been performed to change connection of the MS 2 from the base station device 1b1 to first another base station device 1, to time t2 at which handover is performed to change connection of the MS 2 from the first another base station device 1 to second another base station device 1 or the base station device 1b1 (i.e., the sojourn time in the cell of the first another base station device 1).

Alternatively, the sojourn time may be a time interval from time t1 at which handover has been performed to change connection of the MS 2 from the first another base station device 1 to the second another base station device 1, to time t2 at which handover is performed to change connection of the MS 2 from the first another base station device 1 to the base station device 1b1 (i.e., the sojourn time in the cell of the second another base station device 1).

### 4. Fourth Embodiment

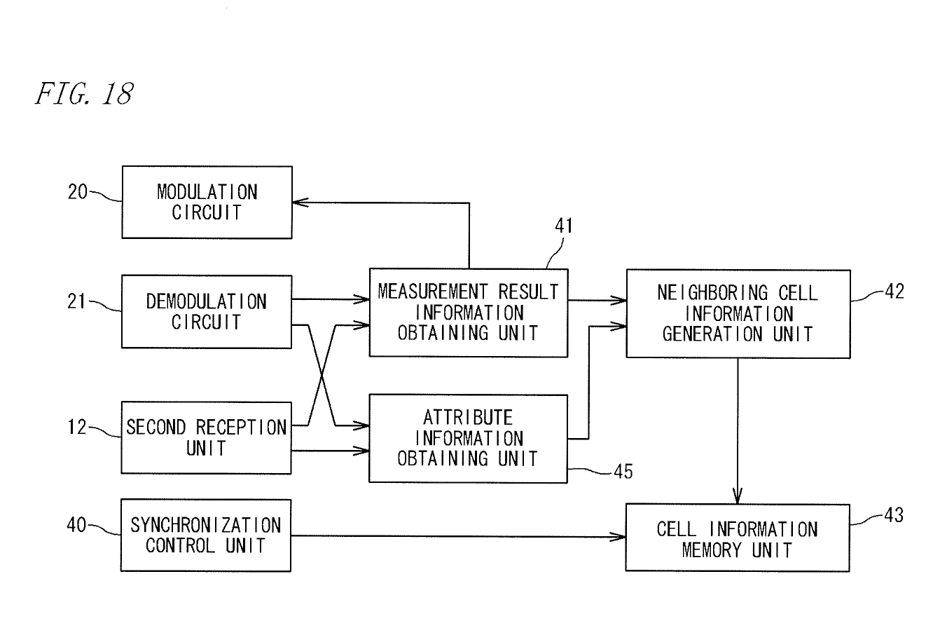

FIG. 18 is a partial block diagram showing a part of an internal configuration of a femto BS 1b according to a fourth embodiment of the present invention. The configuration of a macro BS 1a is substantially the same as that of the femto BS 1b.

The present embodiment is different from the second embodiment in the following points. That is, the femto BS 1b1 includes an attribute information obtaining unit 45 that obtains attribute information indicating an attribute relating to communication connection with another base station device 1. The neighboring cell information generation unit 42 generates and updates neighboring cell information in which the attribute information is associated with the cell ID of the corresponding another base station device 1. The synchronization control unit 40 selects a base station device 1 as a synchronization source in accordance with the attribute information.

The attribute information obtaining unit 45 receives a downlink signal of another base station device 1, which has been received by the second reception unit 12, or a measurement result notification transmitted from an MS 2 connected to the base station device 1b1 that has obtained measurement result information, and obtains attribute information based on the information included in the downlink signal, or the measurement result notification. The attribute information includes access mode information indicating an access mode in which the another base station device 1 is set.

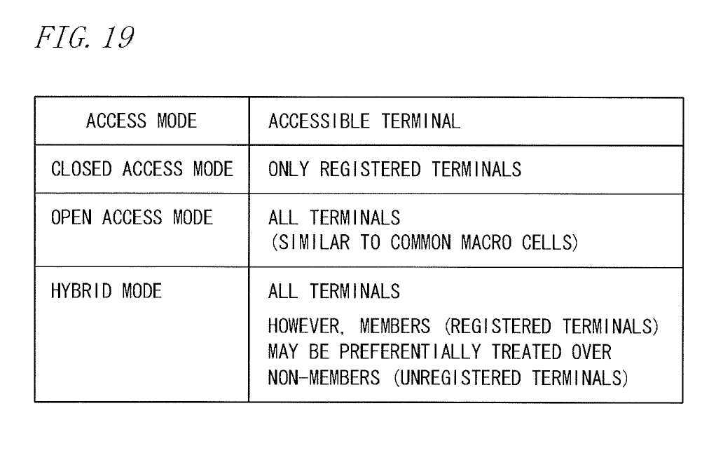

FIG. 19 is a diagram showing access modes in which base station devices 1 are set.

An access mode is a mode that defines a limitation on communication access between a base station device and an MS 2. As shown in FIG. 19, there are three types of access modes, an open access mode, a closed access mode, and a hybrid mode. Each base station device 1 is set in any of these three types of access modes.

The open access mode is a mode in which all MSs 2 are allowed to access. Since a macro BS 1a installed by a telecommunications carrier or the like is highly public, it is usually set in the open access mode.

The closed access mode is a mode in which only MSs 2 registered in a base station device 1 set in this mode are allowed to access.

The hybrid mode is a mode in which all MSs 2 are fundamentally allowed to access, but a registered MS 2 may be treated preferentially in communication resource allocation or the like over an unregistered terminal device.

A femto BS 1b is set in any one of the above-mentioned three modes.

A femto BS 1b is installed by an individual or a company in its own building or a specific space, and the individual or the company that installs the femto BS 1b may desire to limit MSs 2 that are allowed to access the femto BS 1b. In this case, the femto BS 1b is configured to be able to select any one of the above-mentioned three modes in accordance with the situation.

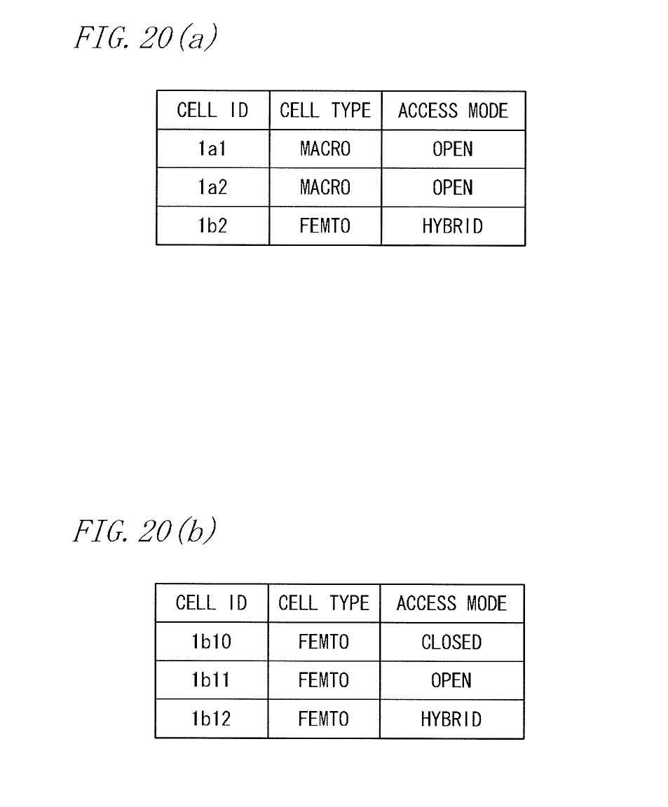

FIG. 20(a) is a diagram showing an example of neighboring cell information generated by the femto BS 1b1 according to the present embodiment.

For example, assuming that the femto BS 1b2 shown in FIG. 8 is set in the hybrid mode, the attribute information obtaining unit 45 obtains access mode information indicating that the femto BS 1b2 is in the hybrid mode. On the other hand, the macro BS 1a1 and the macro BS 1a2 shown in FIG. 8 are set in the open access mode. Accordingly, the attribute information obtaining unit 45 obtains access mode information indicating that the macro BS 1a1 and the macro BS 1a2 are in the open access mode.

The neighboring cell information generation unit 42 associates the access mode information with the corresponding cell ID to generate neighboring cell information shown in FIG. 20(a).

The synchronization control unit 40 selects another base station device 1 to be a synchronization source in accordance with the attribute information included in the neighboring cell information.

More specifically, from among the other base station devices 1 registered in the neighboring cell information, the synchronization control unit 40 preferentially selects a base station device 1 set in the open access mode, followed by a base station device 1 set in the hybrid mode, and a base station device 1 set in the closed access mode in this order of priority.

For example, it is assumed that the neighboring cell information is in the state shown in FIG. 20(a) when the synchronization control unit 40 determines to execute over-the-air synchronization and therefore refers to the neighboring cell information stored in the cell information memory unit 43. In this case, the synchronization control unit 40 preferentially selects the macro BS 1a1 and the macro BS 1a2 in the open access mode over the femto BS 1b2 in the hybrid mode. In the case of FIG. 20(a), since both the macro BS 1a1 and the macro BS 1a2 are in the open access mode, the synchronization control unit 40 selects either of the macro BS 1a1 and the macro BS 1a2 in accordance with another information such as the reception level.

Further, it is assumed that the neighboring cell information is in the state shown in FIG. 20(b) when the synchronization control unit 40 refers to the neighboring cell information. In this case, the synchronization control unit 40 preferentially selects the femto BS 1b11 set in the open access mode, followed by the femto BS 1b10, and the femto BS 1b12 in this order of priority.

Among the above-mentioned access modes, the open access mode in which all MSs 2 are allowed to access is most public, and there is a high possibility that many MSs 2 are connected. On the other hand, the closed access mode is least public, and relatively less number of MSs 2 are connected.

Since the femto BS 1b1 is likely to cause interference to an MS 2 connected to another base station device 1, if the number of MSs 2 connected to the another base station device 1 is great, the possibility of interference is increased.

Accordingly, it is preferable that the femto BS 1b selects another base station device 1 that is highly public, as a synchronization target, when achieving synchronization with the another base station device 1.

In this regard, according to the present embodiment, another base station device 1 to be a synchronization source is selected according to its access mode in the following order of priority: the open access mode, the hybrid mode, and the closed access mode. Therefore, it is possible to select a base station device 1 that is more public, as a synchronization source. As a result, the femto BS 1b can achieve synchronization with another base station device 1 that is highly public and therefore highly likely to cause interference, and can favorably perform the process for avoiding interference.

### Modification of the Fourth Embodiment

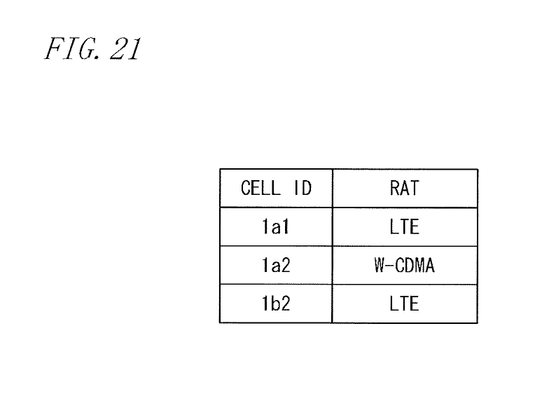

FIG. 21 is a diagram showing an example of neighboring cell information generated by a femto BS 1b according to a modification of the fourth embodiment.

The attribute information obtaining unit 45 according to the modification obtains, as attribute information, RAT information indicating a radio access technology (RAT) of another base station device 1.

Further, as shown in FIG. 21, the neighboring cell information generation unit 42 generates neighboring cell information in which the RAT information is associated with the cell ID of the corresponding base station device 1.

For example, assuming that the RAT of the macro BS 1a2 shown in FIG. 8 is W-CDMA (Wideband Code Division Multiple Access) and the RAT of the macro BS 1a1, the femto BS 1b1, and the femto BS 1b2 is LTE, the attribute information obtaining unit 45 obtains RAT information indicating that the RAT of the macro BS 1a2 is W-CDMA. Further, the attribute information obtaining unit 45 obtains RAT information indicating that the RAT of the macro BS 1a1 and the femto BS 1b2 is LTE.

The neighboring cell information generation unit 42 generates neighboring cell information shown in FIG. 21 in which the RAT information is associated with the corresponding cell ID.

The synchronization control unit 40 selects another base station device 1 to be a synchronization source in accordance with the RAT information as the attribute information included in the neighboring cell information.

More specifically, the synchronization control unit 40 preferentially selects a base station device 1 whose RAT is the same as the RAT of its own base station device, from among the other base station devices 1 registered in the neighboring cell information. The reason is as follows. When two base station devices have the same RAT, synchronization can be achieved between the base station devices, and thereby interference can be favorably avoided. That is, the RAT information configures information indicating whether it is possible to avoid interference that may occur between the base station device 1b1 and the another base station device 1.

For example, it is assumed that the neighboring cell information is in the state shown in FIG. 21 when the synchronization control unit 40 determines to execute over-the-air synchronization and therefore refers to the neighboring cell information stored in the cell information memory unit 43. In this case, the synchronization control unit 40 preferentially selects the macro BS 1a1 and the femto BS 1b2 whose RAT is the same as the RAT of the base station device 1b1, i.e., LTE, over the macro BS 1a2 whose RAT is W-CDMA. In the case of FIG. 21, since the RAT of both the macro BS 1a1 and the femto BS 1b2 is LTE, the synchronization control unit 40 selects either of the macro BS 1a1 and the femto BS 1b2 in accordance with another information such as the reception level.

In this case, since another base station device 1 whose RAT is the same as that of the base station device 1b1 is preferentially selected, over-the-air synchronization can be favorably performed.

### 5. Fifth Embodiment

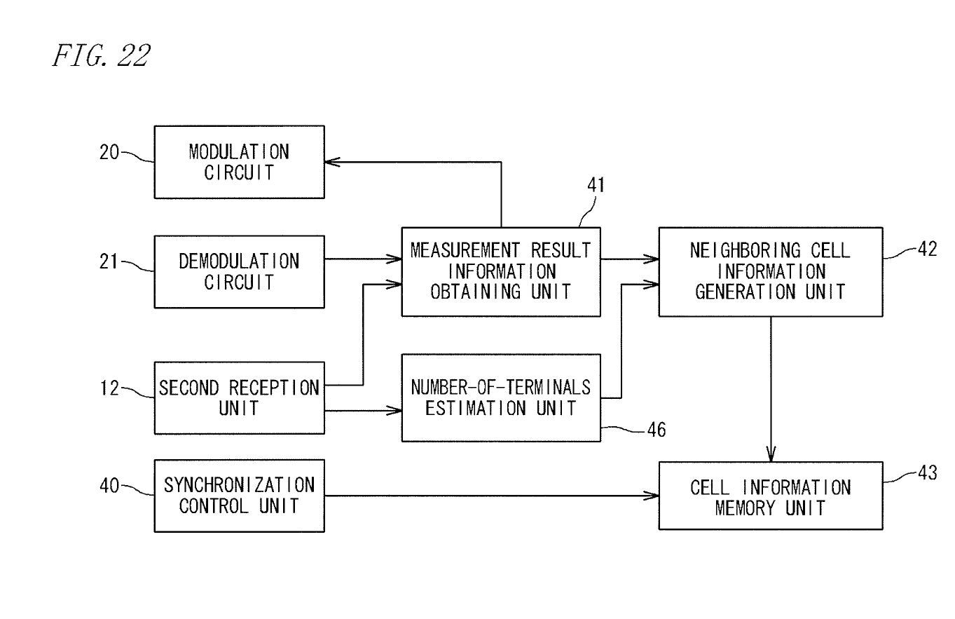

FIG. 22 is a partial block diagram showing a part of an internal configuration of a femto BS 1b according to a fifth embodiment of the present invention. The configuration of a macro BS 1a is substantially the same as that of the femto BS 1b.

The present embodiment is different from the second embodiment in the following points. That is, the femto BS 1b1 includes a number-of-terminals estimation unit 46 that estimates the number of MSs 2 connected to another base station device 1. The neighboring cell information generation unit 42 generates and updates neighboring cell information in which the estimated number of terminals is associated with the cell ID of the corresponding base station device 1. The synchronization control unit 40 selects a base station device 1 to be a synchronization source in accordance with the estimated number of terminals.

The number-of-terminals estimation unit 46 has a function of receiving a downlink signal that has been received from another base station device 1 by the second reception unit 12, and obtaining an average value of the reception level of each resource block, from the downlink signal of the another base station device 1.

The number-of-terminals estimation unit 46 determines whether a resource of an MS 2 is allocated to each resource block, based on the obtained reception level for each resource block, and grasps the resource allocation state of the downlink signal. The number-of-terminals estimation unit 46 estimates the number of MSs 2 connected to the another base station device 1 based on the grasped resource allocation state of the downlink signal.

Further, the number-of-terminals estimation unit 46 has a function of obtaining a resource block allocation scheme of the another base station device 1, from the downlink signal of the another base station device 1.

There are two types of allocation schemes, distributed transmission and localized transmission. The distributed transmission is a scheme in which the resources of respective MSs 2 are evenly distributed throughout a predetermined frequency band width, and transmitted. The localized transmission is a scheme in which the resources of respective MSs 2 are allocated to resource blocks that are continuous in the frequency direction within ranges of specific frequency band widths, respectively, and the resource of an MS 2 is transmitted in a range of a predetermined narrow band.

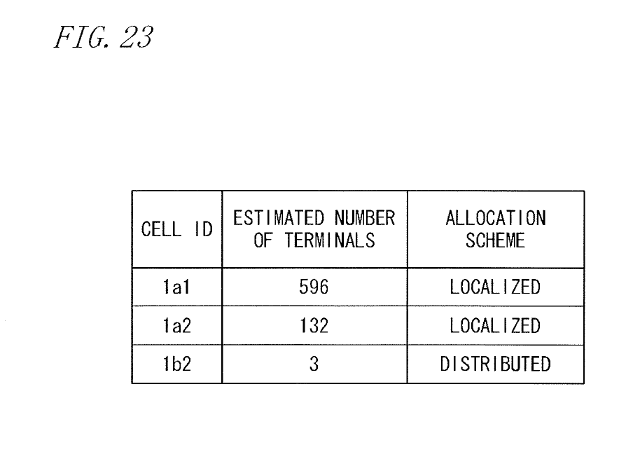

FIG. 23 is a diagram illustrating an example of neighboring cell information generated by the femto BS 1b1 of the present embodiment.

For example, it is assumed that the number-of-terminals estimation unit 46 has estimated the number of MSs 2 connected to each another base station device 1 based on a downlink signal of the base station device 1, and the result is that the estimated number of terminals connected to the macro BS 1a1 shown in FIG. 8 is 596, the estimated number of terminals connected to the macro BS 1a2 is 132, and the estimated number of terminals connected to the femto BS 1b2 is 3. Further, it is assumed that the allocation scheme for the macro BS 1a1 and the macro BS 1a2 is the localized transmission, and the allocation scheme for the femto BS 1b2 is the distributed transmission. The attribute information obtaining unit 45 outputs, to the neighboring cell information generation unit 42, information indicating the estimated numbers of terminals and information indicating the allocation schemes.

The neighboring cell information generation unit 42 generates neighboring cell information shown in FIG. 23 in which the estimated numbers of terminals and the allocation schemes are associated with the corresponding cell IDs.

The synchronization control unit 40 of the femto BS 1b1 of the present embodiment selects a base station device 1 to be a synchronization source, in accordance with the estimated number of terminals included in the neighboring cell information.

More specifically, the synchronization control unit 40 selects a base station device 1 having the largest estimated number of terminals, from among the other base station devices 1 registered in the neighboring cell information.

For example, it is assumed that the neighboring cell information is in the state shown in FIG. 23 when the synchronization control unit 40 determines to execute over-the-air synchronization and therefore refers to the neighboring cell information stored in the cell information memory unit 43. In this case, the synchronization control unit 40 selects the macro BS 1a1 having the largest estimated number of terminals, as a synchronization source.

Since the femto BS 1b1 is likely to cause interference to an MS 2 connected to another base station device 1, if the number of MSs 2 connected to the another base station device 1 is great, the possibility of interference is increased.

Accordingly, when performing synchronization with another base station device 1, the femto BS 1b preferably selects, as a target of the synchronization process, a base station device 1 having larger estimated number of terminals.

In this regard, according to the present embodiment, a base station device 1 having the largest estimated number of terminals is selected as a synchronization source from among the other base station devices 1 registered in the neighboring cell information, and therefore, it is possible to select, as a synchronization source, a base station device 1 that is highly likely to cause interference. As a result, the femto BS 1b can achieve synchronization with the base station device 1 that is highly likely to cause interference, and can favorably perform the process for avoiding interference.

While in the present embodiment the femto BS 1b1 selects a synchronization origin based on only the estimated number of terminals, the femto BS 1b1 may be configured to select a synchronization source in view of the allocation scheme in addition to the estimated number of terminals.

In this case, it is preferable that a base station device 1 whose allocation scheme is the localized transmission is preferentially selected as a synchronization source. The reason is as follows. When the allocation scheme is the localized transmission, the resource of each MS 2 is allocated to a range of a specific frequency band width, as described above. Accordingly, in order to avoid interference between the base station device 1b1 and the another base station device 1, the resources of the respective MSs 2 can be allocated so as not to overlap each other in the frequency direction.

That is, the information indicating the allocation scheme configures information indicating whether interference between the base station device 1b1 and another base station device 1 is avoidable.

Accordingly, if the allocation scheme of the macro BS 1a1 shown in FIG. 23 is the distributed transmission, the synchronization control unit 40 may preferentially select the macro BS 1a2 whose allocation scheme is the localized transmission, although the macro BS 1a1 is larger in the estimated number of terminals than the macro BS 1a2.

### 6. Sixth Embodiment

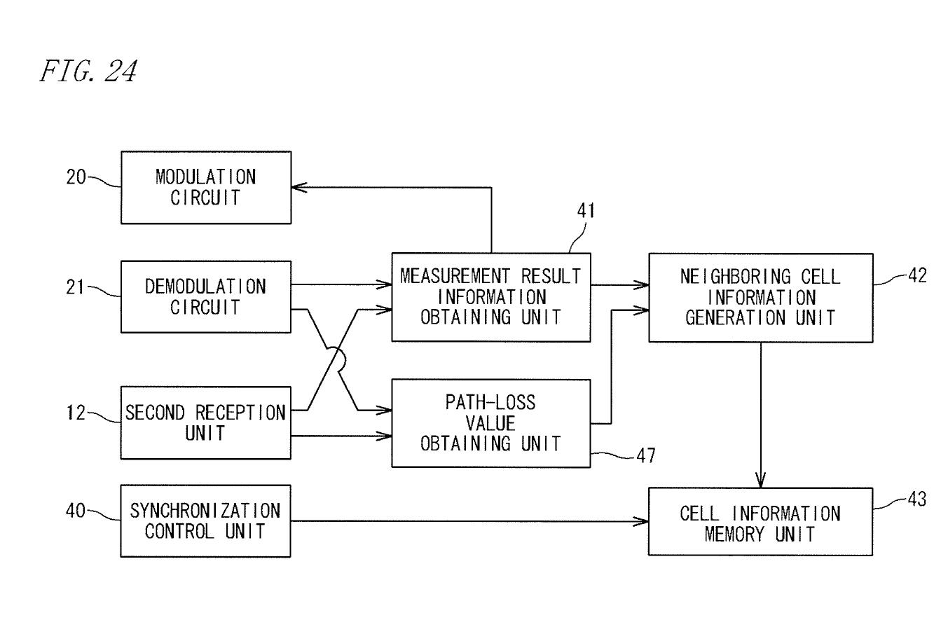

FIG. 24 is a partial block diagram showing a part of an internal configuration of a femto BS 1b according to a sixth embodiment of the present invention. The configuration of a macro BS 1a is substantially the same as that of the femto BS 1b.

The present embodiment is different from the second embodiment in the following points. That is, the femto BS 1b1 includes a path-loss value obtaining unit 47 that obtains a path-loss value between the femto BS 1b1 and another base station device 1. The neighboring cell information generation unit 42 generates and updates neighboring cell information in which the path-loss value is associated with the cell ID of the corresponding base station device 1. The synchronization control unit 40 selects another base station device 1 to be a synchronization origin in accordance with the path-loss value.

The path-loss value obtaining unit 47 receives a downlink signal that has been received from another base station device 1 by the second reception unit 12, or a measurement result notification transmitted from an MS 2 connected to the base station device 1b1 that has received the measurement result information, and obtains a path-loss value between the base station device 1b1 and the another base station device 1 based on the information included in the downlink signal, or the measurement result notification.

The path-loss value obtaining unit 47 obtains the path-loss value of the another base station device 1 as follows. That is, the path-loss value obtaining unit 47 obtains in advance the transmission power value of the another base station device 1 from the downlink signal that has been received from the another base station device 1 by the second reception unit 12, or from the measurement result notification transmitted from the MS 2.

Next, the path-loss value obtaining unit 47 obtains the reception level of the downlink signal of the another base station device 1, from the downlink signal that has been received from the another base station device 1 by the second reception unit 12, or from the measurement result notification transmitted from the MS 2.

The path-loss value obtaining unit 47 obtains the path-loss value from the transmission power value and the reception level of the downlink signal of the another base station device 1, which are obtained as described above.

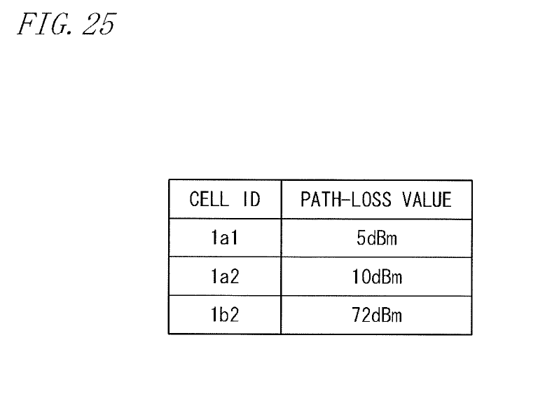

FIG. 25 is a diagram showing an example of neighboring cell information generated by the femto BS 1b1 of the present embodiment.

For example, it is assumed that the path-loss value obtaining unit 47 has obtained the path-loss values of the other base station devices 1, and the result is that the path-loss value of the macro BS 1a1 shown in FIG. 8 is 5 dBm, the path-loss value of the macro BS 1a2 is 10 dBm, and the path-loss value of the femto BS 1b2 is 72 dBm. The path-loss value obtaining unit 47 outputs information indicating these path-loss values to the neighboring cell information generation unit 42.

The neighboring cell information generation unit 42 generates neighboring cell information shown in FIG. 25 in which the path-loss values are associated with the corresponding cell IDs.

The synchronization control unit 40 of the femto BS 1b1 of the present embodiment selects a base station device 1 to be a synchronization source, in accordance with the path-loss values included in the neighboring cell information, as described above.

More specifically, the synchronization control unit 40 selects a base station device 1 having the smallest path-loss value from among the other base station devices 1 registered in the neighboring cell information.

For example, it is assumed that the neighboring cell information is in the state shown in FIG. 25 when the synchronization control unit 40 determines to execute over-the-air synchronization and therefore refers to the neighboring cell information stored in the cell information memory unit 43. In this case, the synchronization control unit 40 selects, as a synchronization source, the macro BS 1a1 having the smallest path-loss value.

The smaller the path-loss value, the higher the possibility that another base station device 1 corresponding to the path-loss value is located near the base station device 1b1. That is, the path-loss value of another base station device 1 configures information whose value is influenced by the positional relationship between the base station device 1b1 and the another base station device 1.

Further, as described above, the closer the positions of neighboring two base station devices 1 are to each other, the higher the possibility that a downlink signal of one of the two base station devices 1 causes interference to an MS 2 connected to the other base station device 1.

According to the present embodiment, since a base station device 1 having the smallest path-loss value is selected as a synchronization source from among the other base station devices 1 registered in the neighboring cell information, it is possible to select, as a synchronization source, a base station device 1 that is located near the base station device 1b1 and is highly likely to cause interference. As a result, the femto BS 1b1 can achieve synchronization with the base station device 1 that is highly likely to cause interference, and can favorably perform the process for avoiding interference.

As described above in detail, the femto BS 1b1 of the present embodiment includes the synchronization control unit 40 that serves as a selection unit for selecting another base station device 1 to be a synchronization source, based on information indicating whether interference can occur due to the relationship between the femto BS 1b1 and the another base station device 1, and therefore, can achieve synchronization with the another base station device 1 that is likely to cause interference. As a result, the femto BS 1b1 can favorably perform the process of avoiding interference.

The synchronization control unit 40 can use identification information indicating either the macro BS 1a or the femto BS 1b, which is described for the first embodiment, as information indicating whether interference can occur due to the relationship between its own base station device and another base station device.

Further, as information indicating whether interference can occur due to the relationship between the own base station device and another base station device, the synchronization control unit 40 can use information indicating the carrier wave frequency of the another base station device 1, information indicating the access mode of the another base station device 1 to the MS 2 connected to the another base station device 1, information indicating the estimated number of MSs 2 connected to the another base station device 1, information indicating the resource block allocation scheme used when the another base station device 1 performs resource allocation to the MS 2 connected to the another base station device 1, or information indicating the power ON/OFF state of the another base station device 1.

The closer the another base station device 1 is to the base station device 1b1, the higher the possibility that the downlink signals from the base station device 1b1 and the another base station device 1 interfere with the MSs 2 connected to the respective base station devices. In order to avoid such interference, it is preferable that the base station device 1b1 achieves inter-base-station synchronization with the another base station device 1 located near the base station device 1b1.

Accordingly, information indicating whether interference can occur due to the relationship between the base station device 1b1 and another base station device 1 is preferably information indicating the positional relationship between the base station device 1b1 and the another base station device 1, or information whose value is influenced by the positional relationship between the base station device 1b1 and the another base station device 1.

In this case, the synchronization control unit 40 selects another base station device 1 to be a synchronization source, in accordance with the information indicating the positional relationship between the base station device 1b1 and the another base station device 1, or the information whose value is influenced by the positional relationship between the base station device 1b1 and the another base station device 1. Therefore, the synchronization control unit 40 can select, as a synchronization source, another base station device 1 that can be determined, by the above-mentioned information, as being relatively near the base station device 1b1 and being highly likely to cause interference.

As a result, the base station device 1b1 can achieve synchronization with the another base station device 1 that is highly likely to cause interference, and can favorably perform the process for avoiding interference.

The synchronization control unit 40 may use positional information obtained by a GPS function, as information indicating the positional relationship between the own base station device and another base station device.

Further, as information whose value is influenced by the positional relationship between the base station device 1b1 and another base station device, the synchronization control unit 40 may use information indicating the detection result when a downlink signal of the another base station device 1 is detected, or the reception level of the downlink signal of the another base station device 1, or the path-loss value between the another base station device 1 and the base station device 1b1.

Further, as the information indicating the detection result when the downlink signal of the another base station device 1 is detected, the synchronization control unit 40 may use the number of times the another base station device 1 is detected within a predetermined time period, the detection ratio between the number of times of detection and the number of trials of detection, the time (last detection time) at which the downlink signal of the another base station device has been detected more recently, or the elapsed time from the last detection time to the present time.

Further, as the information whose value is influenced by the positional relationship between the base station device 1b1 and another base station device 1, the synchronization control unit 40 may use the number of trials of handover of an MS 2 that is performed between the base station device 1b1 and the another base station device 1, or information whose value is influenced by the number of trials of handover.

Moreover, as the information whose value is influenced by the number of trials of handover, the synchronization control unit 40 may use the number of successes of handover and the handover success rate, which are obtained based on the number of trials of handover.

Further, the synchronization control unit 40 may select another base station device 1 to be a synchronization source, based on, in addition to the information indicating whether interference can occur due to the relationship between the base station device 1b1 and the another base station device 1, information indicating whether the interference is avoidable. In this case, it is possible to favorably avoid interference between the base station device 1b1 and the another base station device 1 that can cause interference.

More specifically, as the information indicating whether interference is avoidable, it is possible to use information indicating the type of the radio access technology of the another base station device 1, information indicating the resource block allocation scheme used when the another base station device 1 performs resource allocation to an MS 2 connected to the another base station device 1, or information indicating whether, for example, inter-base-station communication via the X2 interface is possible between the base station device 1b1 and the another base station device 1.

Note that the embodiments disclosed are to be considered in all respects as illustrative and not restrictive. The scope of the invention is indicated by the appended claims rather than by the foregoing meaning, and all changes which come within the meaning and range of equivalency of the claims are therefore intended to be embraced therein.

1. A base station device that performs wireless communication with a terminal device existing in its cell, the base station device comprising:
an obtainment unit that obtains control information for another base station device to achieve synchronization with the another base station device; and
a selection unit that selects the another base station device to be a synchronization source, based on identification information that specifies the type of the another base station device, the identification information being included in the control information.

2. The base station device according to claim 1, wherein
the identification information is either of the following (a) and (b):
(a) type information indicating whether the another base station device is a macro base station or a small base station;
(b) transmission power information of the another base station device.

3. The base station device according to claim 2, wherein
the selection unit selects, as a synchronization source, the another base station device which is a macro base station.

4. The base station device according to claim 3, wherein
the obtainment unit comprises a reception unit that receives a downlink signal transmitted by the another base station device, the downlink signal including the identification information, and
when there are a plurality of the other base station devices which are macro base stations, the selection unit preferentially selects, as a synchronization source, a base station device that transmits a downlink signal having a higher reception power in the reception unit.

5. The base station device according to claim 2, wherein
the selection unit does not select, as a synchronization source, the another base station device which is a small base station.

6. The base station device according to claim 2, wherein
the selection unit selects the another base station device which is a small base station, as a synchronization source, when the another base station device adopts a macro base station as a direct synchronization source.

7. A base station device that performs wireless communication with a terminal device existing in its cell, the base station device comprising:
a selection unit that selects another base station device to be a synchronization source, based on information indicating whether interference can occur due to a relationship between the base station device and the another base station device.

8. The base station device according to claim 7, wherein
the information indicating whether interference can occur due to a relationship between the base station device and the another base station device is identification information that specifies whether the another base station device is a macro base station or a small base station.

9. The base station device according to claim 7, wherein
the information indicating whether interference can occur due to a relationship between the base station device and the another base station device is information indicating a positional relationship between the base station device and the another base station device, or information whose value is influenced by the positional relationship between the base station device and the another base station device.

10. The base station device according to claim 9, wherein
the information whose value is influenced by the positional relationship between the base station device and the another base station device is information relating to a detection result obtained when a downlink signal from the another base station device is detected, or a reception level of the downlink signal from the another base station device, or a path-loss value between the base station device and the another base station device.

11. The base station device according to claim 10, wherein
the information relating to a detection result obtained when a downlink signal from the another base station device is detected is the number of times the another base station device is detected within a predetermined time period, or a detection rate that is a ratio of the number of times the another base station device is detected, to the number of times the detection is executed.

12. The base station device according to claim 10, wherein
the information relating to a detection result obtained when a downlink signal from the another base station device is detected is the time at which the downlink signal from the another base station device has been detected most recently, or the elapsed time from the time at which the downlink signal from the another base station device has been detected most recently to the present time.

13. The base station device according to claim 9, wherein
the information whose value is influenced by the positional relationship between the base station device and the another base station device is information relating to the number of trials of handover by the terminal device, the handover being performed between the base station device and the another base station device, or information whose value is influenced by the number of trials of handover.

14. The base station device according to claim 7, wherein
the information indicating whether interference can occur due to a relationship between the base station device and the another base station device is information indicating a carrier wave frequency of the another base station device, information indicating an access mode of the another base station device to a terminal device connected to the another base station device, the estimated number of terminal devices connected to the another base station device, or information indicating a power ON/OFF state of the another base station device.

15. The base station device according to claim 7, wherein
the selection unit selects the another base station device to be a synchronization source, based on, in addition to the information indicating whether interference can occur due to a relationship between the base station device and the another base station device, information indicating whether the interference is avoidable.

16. The base station device according to claim 15, wherein
the information indicating whether the interference is avoidable is information indicating the type of a radio access technology adopted by the another base station device, information indicating a resource block allocation scheme used when the another base station device performs resource allocation to a terminal device connected to the another base station device, or information indicating whether inter-base-station communication is possible between the base station device and the another base station device.
